(19) United States
(12) Patent Application Publication
(10) Pub. No.: US 2026/0280807 A1
(43) Pub. Date: Sep. 17, 2026

(54) BASE STATION APPARATUS, TERMINAL APPARATUS, AND COMMUNICATION METHOD

(71) Applicant: SHARP KABUSHIKI KAISHA, Sakai City, Osaka (JP)

(72) Inventors: KOZUE YOKOMAKURA, Sakai City, Osaka (JP); TOSHIZO NOGAMI, Sakai City, Osaka (JP); HIROKI TAKAHASHI, Sakai City, Osaka (JP); Makoto KITAHARA, Sakai City, Osaka (JP)

(21) Appl. No.: 19/471,734

(22) PCT Filed: Apr. 5, 2024
(86) PCT No.: PCT/JP2024/014168

§ 371 Date: Oct. 2, 2025

(30) Foreign Application Priority Data
Apr. 6, 2023 (JP) 2023-062004

(51) Int. Cl. H04L 5/00; H04W 72/40

(52) U.S. Cl. CPC H04L 5/0051; H04W 72/40

(57) ABSTRACT

A terminal apparatus in communication with a base station apparatus includes a higher layer processing unit configured to receive a first parameter set and a second parameter set. Each of the first parameter set and the second parameter set includes the number of symbols of an SL-PRS, information indicating the position of a first symbol of the SL-PRS, a Comb size, and a resource element offset. The first parameter set is a parameter set used for a Dedicated resource pool. The second parameter set is a parameter set used for a Shared resource pool.

### TECHNICAL FIELD

The present invention relates to a base station apparatus, a terminal apparatus, and a communication method.

This application claims priority to JP 2023-062004 filed on Apr. 6, 2023, the contents of which are incorporated herein by reference,

### BACKGROUND ART

A radio access method and a radio network for cellular mobile communication (hereinafter referred to as “New Radio (NR)”, “Long Term Evolution (LTE)”, “Evolved Universal Terrestrial Radio Access (EUTRA)”, a succeeding system thereof, or the like) have been studied in the 3^{rd} Generation Partnership Project (3GPP). In NR and LTE, a base station apparatus may also be referred to as a next generation NodeB (gNodeB) or an evolved NodeB (eNodeB), and a terminal apparatus may also be referred to as a User Equipment (UE). NR and LTE are cellular communication systems in which multiple areas covered by base station apparatuses are arranged in a form of cells. One base station apparatus may manage one of multiple serving cells,

The 3GPP has been studying a next generation radio communication standard NR to make a proposal for International Mobile Telecommunication (IMT)-2020 that is the standard of a next generation mobile communication system developed by the International Telecommunication Union (ITU) (NPL 1). NR is to satisfy requirements for three scenarios including enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology”, RP-160671, NTT DOCOMO, 3GPP TSG RAN Meeting #71, Goteborg, Sweden, 7 to 10 Mar., 2016.

### SUMMARY OF INVENTION

### Technical Problem

An aspect of the present invention provides a terminal apparatus, a base station apparatus, and a communication method used for the terminal apparatus or the base station apparatus that efficiently perform communication.

### Solution to Problem

(1) A first aspect of the present embodiment of the present invention is a terminal apparatus for communicating with a base station apparatus, the terminal apparatus including a higher layer processing unit configured to receive a first parameter set and a second parameter set, wherein each of the first parameter set and the second parameter set includes the number of symbols of an SL-PRS, information indicating a position of a first symbol of the SL-PRS, a Comb size, and a resource element offset, the first parameter set is a parameter set used for a Dedicated resource pool, and the second parameter set is a parameter set used for a Shared resource pool.
(2) The base station apparatus according to the first aspect of the present embodiment of the present invention selects one piece of information from the first information as second information, includes the second information in a DCI format, and transmits the DCI format to the terminal apparatus.
(3) In the base station apparatus according to the first aspect of the present embodiment of the present invention, the parameter set is some or all of the number of symbols of an SL-PRS, a symbol offset of the SL-PRS, a comb size, and a resource element offset.
(4) A second aspect of the present embodiment of the present invention is a base station apparatus for communicating with a terminal apparatus, the base station apparatus including a higher layer processing unit configured to configure a first parameter set and a second parameter set, wherein each of the first parameter set and the second parameter set includes the number of symbols of an SL-PRS, information indicating a position of a first symbol of the SL-PRS, a Comb size, and a resource element offset, the first parameter set is a parameter set used for a Dedicated resource pool, and the second parameter set is a parameter set used for a Shared resource pool.
(5) A third aspect of the present embodiment of the present invention is a communication method of a terminal apparatus for communicating with a base station apparatus, the communication method including receiving a first parameter set and a second parameter set, wherein each of the first parameter set and the second parameter set includes the number of symbols of an SL-PRS, information indicating a position of a first symbol of the SL-PRS, a Comb size, and a resource element offset, the first parameter set is a parameter set used for a dedicated resource pool, and the second parameter set is a parameter set used for a shared resource pool.

### Advantageous Effects of Invention

According to an aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between N^{slot}_{symb}, an SCS configuration μ, and a CP configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid according to an aspect of the present embodiment.

FIG. 5 is a schematic block diagram illustrating a configuration of a terminal apparatus 1 according to an aspect of the present embodiment.

FIG. 6 is a schematic block diagram illustrating a configuration of a base station apparatus 3 according to an aspect of the present embodiment.

FIG. 7 is a diagram illustrating a configuration example of an SS/PBCH block according to an aspect of the present embodiment.

FIG. 8 is a diagram illustrating an example of a monitoring opportunity for a search space set according to an aspect of the present embodiment.

FIG. 9 is a diagram illustrating a procedure of sidelink RRC reconfiguration according to an aspect of the present embodiment.

FIG. 10 is a diagram illustrating an example of an SL-PRS configuration table according to an aspect of the present embodiment.

FIG. 11 is a diagram illustrating an example of a configuration method in a case that multiple pieces of SL-PRS configuration information are configured in the base station apparatus according to one aspect of the present embodiment.

FIG. 12 is a diagram illustrating an example of a configuration method in a case that one piece of SL-PRS configuration information is configured in the base station apparatus according to one aspect of the present embodiment.

FIG. 13 is a diagram illustrating an example of a configuration method in a case that multiple pieces of SL-PRS configuration information are configured in the terminal apparatus according to one aspect of the present embodiment.

FIG. 14 is a diagram illustrating an example of a configuration method in a case that one piece of SL-PRS configuration information is configured in the terminal apparatus according to one aspect of the present embodiment.

### DESCRIPTION OF EMBODIMENTS

An embodiment of the present invention will be described below. Note that a function floor(CX) may be a floor function for a real number CX. For example, floor(CX) may be a function that provides the maximum integer in a range of not exceeding the real number CX. A function ceil(CX) may be a ceiling function for a real number CX. For example, ceil(CX) may be a function that provides the minimum integer in a range of not falling below the real number CX. A function mod(EX, FX) may be a function that provides a remainder obtained by dividing EX by FX. The function mod(EX, FX) may be a function that provides a value corresponding to a remainder obtained by dividing EX by FX. A function exp(GX) represents e\hat{ }GX. Here, e is a Napier's constant. (HX)\hat{ }(IX) represents HX to the Ix-th power.

“A and/or B” may be a term including “A”, “B”, or “A and B”.

The fact that a parameter or information indicates one or multiple values may mean that the parameter or the information includes at least a parameter or information indicating the one or the multiple values. A higher layer parameter may be a single higher layer parameter. The higher layer parameter may be an Information Element (IE) including multiple parameters.

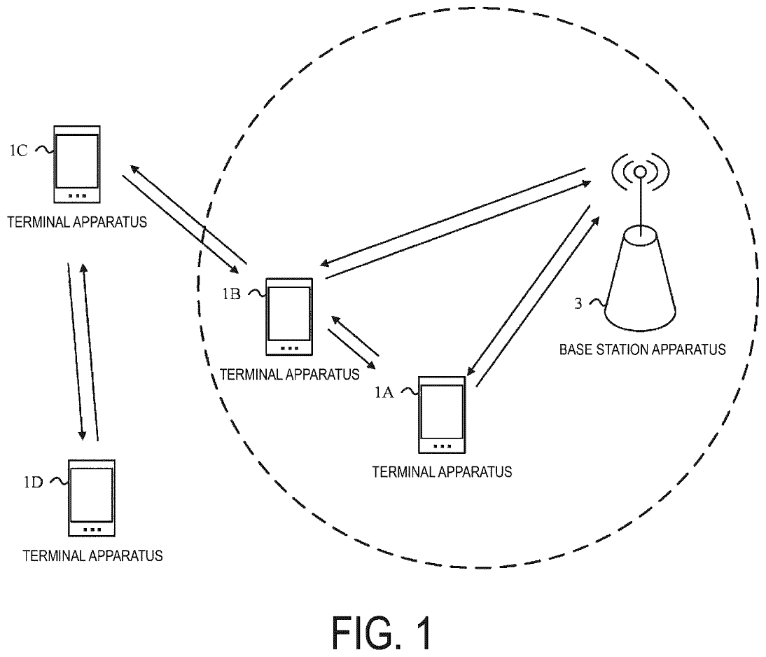

FIG. 1 is a conceptual diagram of a radio communication system according to an aspect of the present embodiment. In FIG. 1, a radio communication system includes terminal apparatuses 1A to 1D and a base station apparatus 3 (gNB). The terminal apparatuses 1A to 1D may be hereinafter also referred to as a terminal apparatus 1 (UE).

In FIG. 1, the terminal apparatus 1A and the terminal apparatus 1B are positioned inside coverage of the base station apparatus 3. Inside the coverage of the base station apparatus 3, the terminal apparatus 1 may be connected to the base station apparatus 3. A link from the terminal apparatus 1 to the base station apparatus 3 is referred to as an uplink (UL), and a link from the base station apparatus 3 to the terminal apparatus 1 is referred to as a downlink (DL). The uplink and the downlink may be connected with a Uu interface. The terminal apparatus 1C and the terminal apparatus 1D are positioned outside the coverage area of the base station apparatus 3.

In FIG. 1, sidelink communication may be performed between terminal apparatuses. The sidelink communication refers to performing communication between terminal apparatuses by using a radio network technology without going through a network node. A sidelink is a radio link between terminal apparatuses with which the sidelink communication is performed. The sidelink may be connected with a PC5 interface. Note that the terminal apparatuses that perform the sidelink communication are not limited to two terminal apparatuses and may be three or more terminal apparatuses.

Positioning refers to measuring the position of a terminal apparatus. Sidelink positioning refers to performing the positioning by using the sidelink communication. The sidelink positioning may be applied to use cases such as V2X, IIoT, Public Safety, Commercial, and the like. In a case that at least two terminal apparatuses are involved in the positioning for V2X and Public Safety use cases, there may be three network coverage scenarios. For example, in a case of two terminal apparatuses, an In-coverage scenario refers to a case that both terminal apparatuses are in the network. Partial coverage means that one terminal apparatus is positioned inside the network coverage but the other terminal apparatus is positioned outside the network coverage. An Out-of-coverage scenario refers to a case that the both terminal apparatuses are outside the network coverage. The terminal apparatus may transition between scenarios of In-coverage, Partial coverage, and Out-of-coverage.

For example, in FIG. 1, the sidelink between the terminal apparatus 1A and the terminal apparatus 1B is the In-coverage scenario, the sidelink between the terminal apparatus 1B and the terminal apparatus 1C is the Partial coverage scenario, and the sidelink between the terminal apparatus 1C and the terminal apparatus 1D is the Out-of-coverage scenario. Note that, in the communication system according to the present embodiment, these scenarios may transition with the movement of the terminal apparatus 1. Further, the configuration of the communication system according to the present embodiment may include a part of the three scenarios. For example, only the Out-of-coverage scenario may be included.

An operation scenario in the sidelink communication may be the PC5 interface alone or a combination of the Uu interface and the PC5 interface. For example, the terminal apparatus 1 and another terminal apparatus 1 may be connected to each other with the PC5 interface, and may perform the sidelink positioning via the PC5 interface. In addition, for example, the base station apparatus 3 and the terminal apparatus 1A may be connected to each other with the Uu interface, the terminal apparatus 1A and the terminal apparatus 1B may be connected to each other with the PC5 interface, and the positioning may be performed by combining the positioning via the Uu interface and the sidelink positioning via the PC5 interface.

Network-based positioning is a solution in which a position of a terminal apparatus is calculated by a network node. For the network-based positioning, the terminal apparatus may notify the network of information necessary for the calculation. For example, in the Network-based positioning, a terminal apparatus may notify a Location Management Function (LMF) server of information necessary for calculating the position of the terminal apparatus, and the LMF may calculate the position of the terminal apparatus. UE-based positioning is a solution in which a position of a terminal apparatus is calculated by the terminal apparatus.

Note that FIG. 1 is an example, and in the communication system according to the present embodiment, a terminal apparatus that does not perform the sidelink communication and/or the sidelink positioning may be included and the terminal apparatus performs processing corresponding to a function or a configuration that the terminal apparatus has. Further, for example, in the communication system according to the present embodiment, a base station apparatus that does not perform operations of the sidelink communication and/or the sidelink positioning may be included and the base station apparatus performs processing corresponding to a function or a configuration that the base station apparatus has.

In the V2X use case, a UE involved in the positioning may be installed in a vehicle, a Road Side Unit (RSU) or a device of a road user. Different UEs may have different power supply limitations. For example, a UE used by a road user may have a limited battery capacity compared with a UE installed in a vehicle or a road side unit.

The base station apparatus 3 may include one or multiple transmitting apparatuses (or transmitting points, transmitting apparatuses, reception apparatuses, transmitting points, or reception points). In a case that the base station apparatus 3 includes multiple transmitting apparatuses, the multiple transmitting apparatuses may be arranged at different positions, respectively.

The base station apparatus 3 may provide one or multiple serving cells. One serving cell may be defined as a set of resources used for radio communication. The serving cell is also referred to as a cell.

The serving cell may include at least one downlink component carrier (downlink carrier) and/or one uplink component carrier (uplink carrier). The serving cell may include at least two or more downlink component carriers, and/or two or more uplink component carriers. The downlink component carrier and the uplink component carrier are also referred to as a component carrier (carrier). The uplink component carrier may be used for the sidelink communication.

For example, one resource grid may be provided for one component carrier. For example, one resource grid may be provided for one component carrier and a Subcarrier Spacing (SCS) configuration u. Here, the Subcarrier Spacing is also referred to as numerology. The resource grid includes N^{size,μ}_{grid,x}N^{RB}_{sc} subcarriers. The resource grid starts from a common resource block with an index of N^{start,μ}_{grid}. The common resource block with the index of N^{start,μ}_{grid} is also referred to as a reference point of the resource grid. The resource grid includes N^{subframe,μ}_{symb} OFDM symbols. A subscript x indicates a transmission direction and indicates either of the downlink or the uplink. One resource grid is provided for an antenna port p, an SCS configuration u, and the transmission direction. The resource grid may be applied to the downlink, the uplink, and/or the sidelink.

The resource grid is also referred to as a carrier.

N^{size,μ}_{grid,x} and N^{start,μ}_{grid} are given based on at least an RRC parameter (for example, the RRC parameter referred to as a Carrier Bandwidth). The RRC parameter is used to define one or multiple SCS dedicated carriers. One resource grid corresponds to one SCS dedicated carrier. One component carrier may include one or multiple SCS dedicated carriers. Information of the SCS dedicated carrier may be included in a system information block. For each SCS dedicated carrier, a subcarrier spacing configuration u may be provided.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In the downlink, at least Cyclic Prefix-Orthogonal Frequency Division Multiplex (CP-OFDM) is used. In the uplink, either of CP-OFDM or Discrete Fourier Transform-spread-Orthogonal Frequency Division Multiplex (DFT-s-OFDM) is used. DFT-s-OFDM may be given by applying Transform precoding to the CP-OFDM. The CP-OFDM is the OFDM that uses a Cyclic Prefix (CP).

The OFDM symbol may be a term including the CP added to the OFDM symbol. That is, one OFDM symbol may include the OFDM symbol itself and the CP added to the OFDM symbol itself.

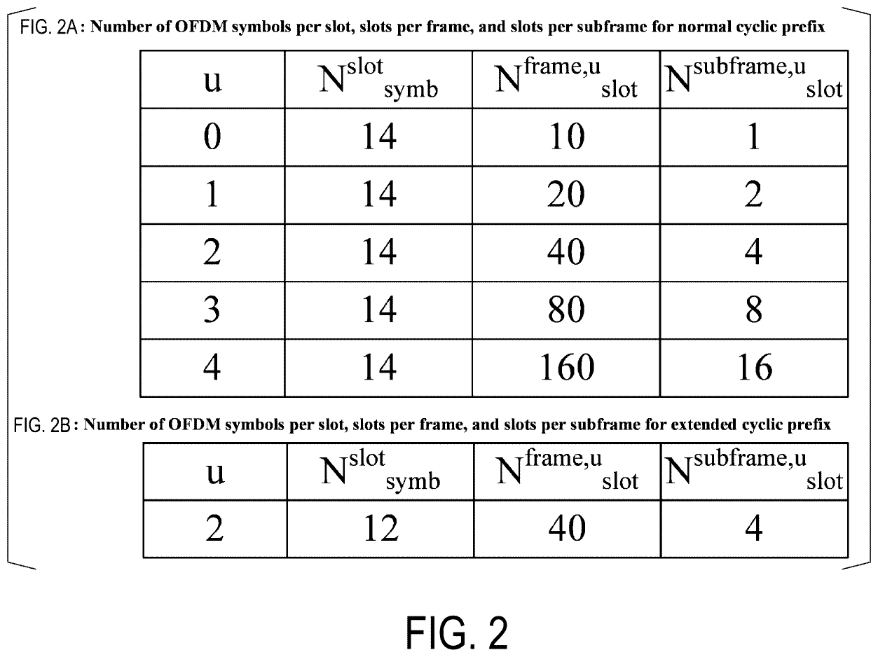

FIG. 2 is an example illustrating a relationship between N^{slot}_{symb}, the SCS configuration μ (also referred to a subcarrier spacing configuration u), and the CP configuration according to an aspect of the present embodiment. In FIG. 2A, for example, in a case that the SCS configuration μ is 2 and the CP configuration is a normal CP (NCP), N^{slot}_{symb}=14, N^{frame,μ}ₛₗₒₜ=40, and N^{subframe,μ}ₛₗₒₜ=4. In FIG. 2B, for example, in a case that the SCS configuration μ is 2 and the CP configuration is an extended CP (ECP), N^{slot}_{symb}=12, N^{frame,μ}ₛₗₒₜ=40, and N^{subframe,μ}ₛₗₒₜ=4. The subcarrier spacing configuration u may be applied to the downlink, the uplink and/or the sidelink.

In the radio communication system, a time unit T_{c} may be used for representation of a length in a time domain. The time unit T_{c} may be given by T_{c}=1/(Δfₘₐₓ·N_{f}) (Δfₘₐₓ may be represented as dfₘₐₓ). The Δfₘₐₓ may be the maximum value of the SCS supported in the radio communication system. The Δfₘₐₓ may be Δfₘₐₓ=480 kHz. N_{f} may be N_{f}=4096. A constant κ is κ=Δfₘₐₓ·N_{f}/(Δf_{ref}N_{f,ref})=64. Δf_{ref} may be 15 KHz. N_{f,ref} may be 2048.

Transmission of a signal in a downlink and/or transmission of a signal in an uplink may include a radio frame (system frame or frame) of a length T_{f}. T_{f}=(Δfₘₐₓ·N_{f}/100)*Tₛ=10 ms. One frame includes 10 subframes. A length of the subframe is T_{sf}=(Δfₘₐₓ·N/1000)*Tₛ=1 ms. The number of OFDM symbols per subframe is N^{subframe,μ}_{symb}=N^{slot}_{symb}*N^{subframe,μ}ₛₗₒₜ.

For a certain SCS configuration u, the number and indexes of slots included in one subframe may be given. For example, a slot number (also referred to as a slot index) n^{μ}ₛ may be given in a subframe in a range from 0 to N^{subframe,μ}ₛₗₒₜ−1 in an ascending order. For the SCS configuration μ, the number and indexes of slots included in one frame may be given. The slot number n^{μ}_{s,f} may be given in a frame in a range from 0 to N^{frame,μ}ₛₗₒₜ−1 in an ascending order. N^{slot}_{symb} continuous OFDM symbols may be included in one slot. N^{slot}_{symb} may be 14.

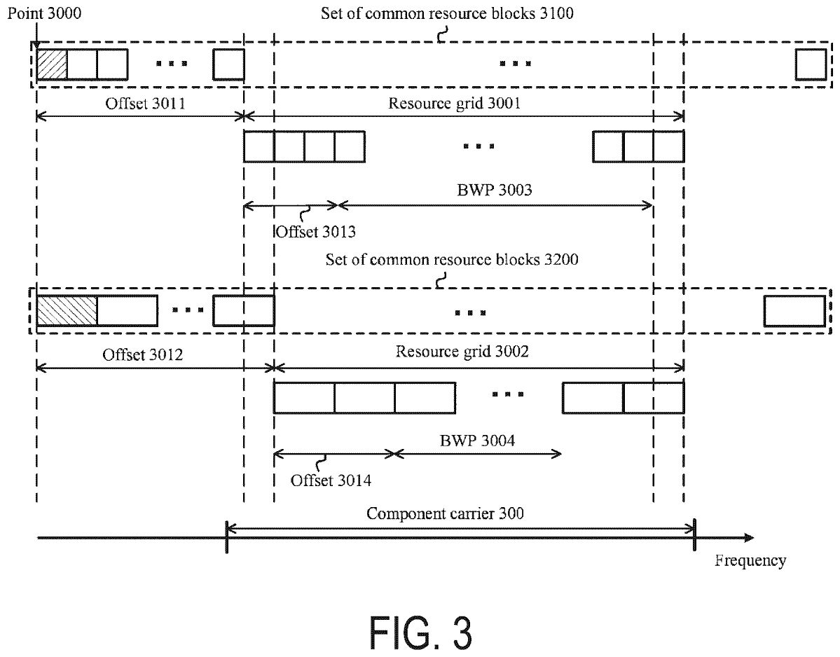

FIG. 3 is a schematic diagram illustrating an example of the resource grid in the subframe according to an aspect of the present embodiment. A horizontal axis of FIG. 3 represents a frequency domain. FIG. 3 illustrates a configuration example of a resource grid of a subcarrier spacing configuration u=u₁ in a component carrier 300, and a configuration example of a resource grid of a subcarrier spacing configuration u=u₂ in a component carrier. One or more subcarrier spacing configurations may be set for one component carrier. Although u₁=u₂−1 is assumed in FIG. 3, aspects of the present embodiment are not limited to the condition u₁=u₂=1.

The component carrier 300 is a band having one predetermined width in a frequency domain.

A point 3000 is a reference to define a subcarrier. The point 3000 is also referred to as a point A. A common resource block (CRB) set 3100 is a set of common resource blocks for the subcarrier spacing configuration u₁.

In the common resource block set 3100, a common resource block including the point 3000 (block indicated by upper right diagonal lines in FIG. 3) is also referred to as a reference point of the common resource block set 3100. The reference point of the common resource block set 3100 may be a common resource block with an index 0 in the common resource block set 3100.

An offset 3011 is an offset from the reference point of the common resource block set 3100 to a reference point of a resource grid 3001. The offset 3011 is relatively specified for the subcarrier spacing configuration u₁ according to the number of common resource blocks. The resource grid 3001 includes N^{size,μ}_{grid1,x} common resource blocks starting from the reference point of the resource grid 3001.

An offset 3013 is an offset from the reference point of the resource grid 3001 to a reference point (N^{start,u}_{BWP,i1}) of a BandWidth Part (BWP) 3003 with an index i1.

A common resource block set 3200 is a set of common resource blocks for the subcarrier spacing configuration u₂.

In the common resource block set 3200, a common resource block including the point 3000 (block indicated by upper left diagonal lines in FIG. 3) is also referred to as a reference point of the common resource block set 3200. The reference point of the common resource block set 3200 may be a common resource block with an index 0 in the common resource block set 3200.

An offset 3012 is an offset from a reference point of a common resource block set 3300 to a reference point of a resource grid 3002. The offset 3012 is specified for the subcarrier spacing configuration u=u₂ according to the number of common resource blocks. The resource grid 3002 includes N^{size,u}_{grid2,x} common resource blocks starting from the reference point of the resource grid 3002.

An offset 3014 is an offset from the reference point of the resource grid 3002 to a reference point (N^{start,u}_{BWP,i2}) of a BandWidth Part (BWP) 3004 with an index i2.

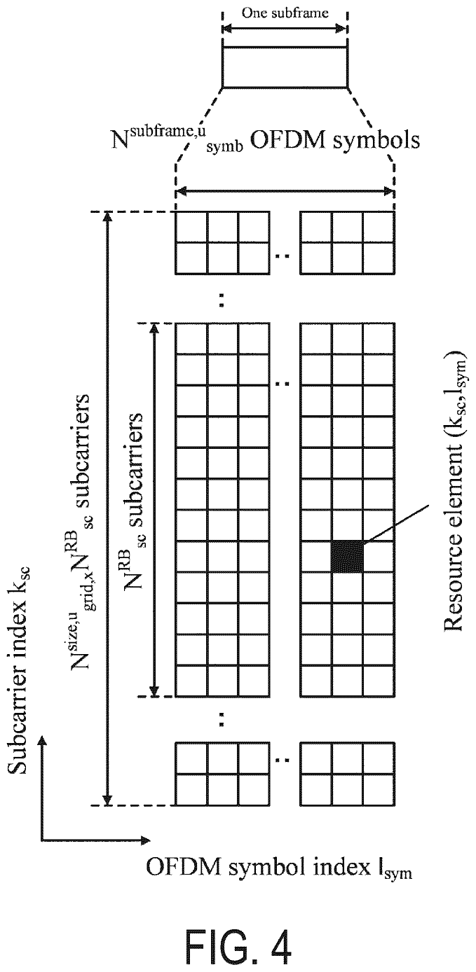

FIG. 4 is a diagram illustrating a configuration example of the resource grid 3001. In the resource grid of FIG. 4, a horizontal axis indicates an OFDM symbol index l_{sym}, and a vertical axis indicates a subcarrier index k_{sc}. The resource grid 3001 includes N^{size,u}_{grid1,x}N^{RB}_{sc} subcarriers, and N^{subframes,u}_{symb} subcarrier OFDM symbols. In the resource grid, a resource specified by the subcarrier index k_{sc} and the OFDM symbol index l_{sym} is also referred to as a resource element (RE).

The resource block (RB) includes N^{RB}_{sc} continuous subcarriers. The resource block is a general term for a common resource block, a Physical Resource Block (PRB), and a Virtual Resource Block (VRB). For example, N^{RB}_{sc} may be 12.

A unit of a resource block is a set of resources corresponding to one OFDM symbol in one resource block. That is, one resource block unit includes 12 resource elements corresponding to one OFDM symbol in one resource block.

The common resource blocks for a subcarrier spacing configuration u are assigned indexes, in a common resource block set, from 0 in a frequency domain in an ascending order. An index n^{u}_{PRB} of a resource block related to the subcarrier spacing configuration u satisfies a relationship of n^{u}_{CRB}=n^{u}_{PRB}+N^{start,u}_{BWP,i}, N^{start,u}_{BWP,i} indicates a reference point of a BWP with an index i.

The BWP is defined as a subset of a common resource block included in a resource grid. The BWP includes N^{size,u}_{BWP,i} resource blocks starting from the reference point N^{start,u}_{BWP,i}. The BWP for a downlink component carrier is also referred to as a downlink BWP. The BWP for an uplink component carrier is also referred to as an uplink BWP. The BWP for a sidelink component carrier is also referred to as a sidelink BWP.

An antenna port is defined in a manner in which a channel through which a symbol is communicated in one antenna port can be inferred from a channel through which another symbol is transmitted in the same antenna port. For example, the channel mentioned here may correspond to a physical channel. For example, the symbol mentioned here may correspond to an OFDM symbol. For example, the symbol mentioned here may correspond to a resource block unit. For example, the symbol mentioned here may correspond to a resource element.

In a case that large scale property of a channel through which a symbol is communicated in one antenna port can be inferred from a channel through which a symbol is transmitted in another antenna port, the two antenna ports may be referred to as being Quasi Co-Located (QCL). The large scale property includes one or multiple of a delay spread, a Doppler spread, a Doppler shift, an average gain, an average delay, and a beam parameter (a spatial reception parameter, spatial Rx parameters).

Carrier aggregation may be communication performed by using multiple aggregated serving cells. The carrier aggregation may be communication performed by using multiple aggregated component carriers. The carrier aggregation may be communication performed by using multiple aggregated downlink component carriers. The carrier aggregation may be communication performed by using multiple aggregated uplink component carriers. The carrier aggregation may be communication performed by using multiple aggregated sidelink component carriers.

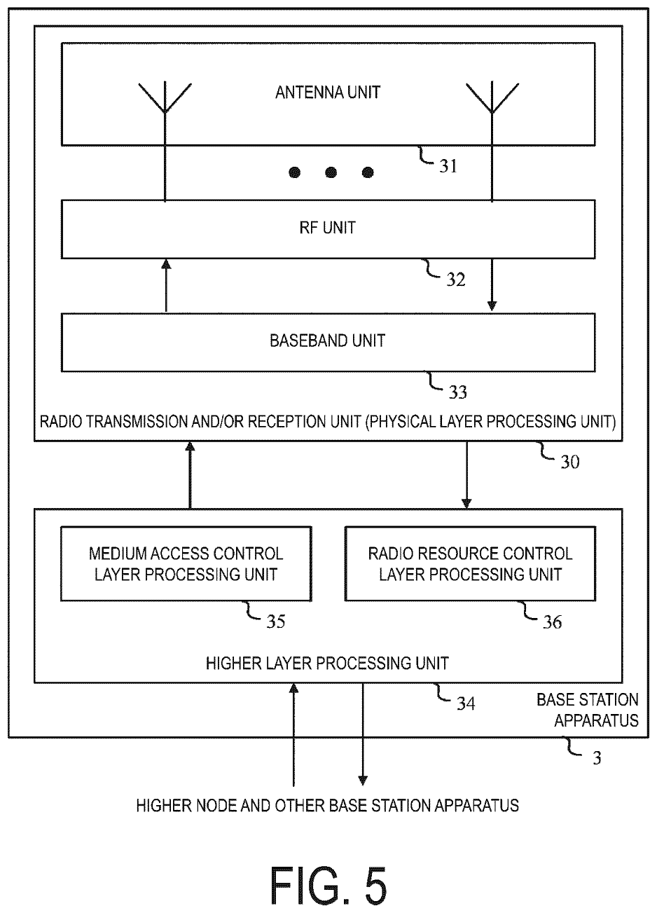

FIG. 5 is a block diagram illustrating a configuration example of the base station apparatus 3. As illustrated in FIG. 5, the base station apparatus 3 at least includes a part or all of a radio transmission and/or reception unit (physical layer processing unit) 30 and a higher layer processing unit 34. The radio transmission and/or reception unit 30 at least includes a part or all of an antenna unit 31, a Radio Frequency (RF) unit 32, and a baseband unit 33. The higher layer processing unit 34 at least includes a part or all of a medium access control layer processing unit 35 and a radio resource control layer processing unit 36.

The radio transmission and/or reception unit 30 includes at least a part or all of a radio transmitting unit 30a and a radio receiving unit 30b. The configuration of the baseband unit 33 included in the radio transmitting unit 30a and the configuration of the baseband unit 33 included in the radio receiving unit 30b may be the same or different from each other. The configuration of the RF unit 32 included in the radio transmitting unit 30a and the configuration of the RF unit 32 included in the radio receiving unit 30b may be the same or different from each other. The configuration of the antenna unit 31 included in the radio transmitting unit 30a and the configuration of the antenna unit 31 included in the radio receiving unit 30b may be the same or different from each other.

The higher layer processing unit 34 provides downlink data (transport block) to the radio transmission and/or reception unit 30 (or the radio transmitting unit 30a). The higher layer processing unit 34 performs processing of a medium access control (MAC) layer, a packet data convergence protocol (PDCP) layer, a radio link control (RLC) layer, and/or an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 configures the RRC parameter based on an RRC message received from the terminal apparatus 1.

The radio resource control layer processing unit 36 configures a control resource set for the terminal apparatus 1. Multiple PDCCH candidates are included (configured) in the configured control resource set. The radio resource control layer processing unit 36 configures a search space for the terminal apparatus 1. The radio resource control layer processing unit 36 configures a DCI format monitored in the search space for the terminal apparatus 1.

The radio resource control layer processing unit 36 configures the DCI format applied for the terminal apparatus 1 in the control resource set. The radio resource control layer processing unit 36 generates an RRC signalling indicating the DCI format applied for the terminal apparatus 1. The radio resource control layer processing unit 36 configures one or more DCI formats applied in the radio transmitting unit 30a.

The radio resource control layer processing unit 36 performs configurations related to multiple search spaces. Each of the configurations related to the multiple search spaces is indexed.

The radio resource control layer processing unit 36 configures a resource for transmitting a HARQ-ACK for the terminal apparatus 1. The radio resource control layer processing unit 36 configures a resource for transmitting the HARQ-ACK for a PDSCH in a downlink frequency band (cell, component carrier, carrier). The radio resource control layer processing unit 36 configures a resource for transmitting the HARQ-ACK for the PDSCH in an uplink frequency band (cell, component carrier, carrier).

The radio resource control layer processing unit 36 performs a configuration related to a CSI feedback (transmission of channel state information) for the terminal apparatus 1. The radio resource control layer processing unit 36 configures a transmission periodicity of the CSI feedback, a transmission initiation timing (offset) of the CSI feedback, a type of information of the CSI feedback, and the like. The radio resource control layer processing unit 36 performs configurations related to the multiple pieces of CSI feedback. Each of the configurations related to the multiple pieces of CSI feedback is indexed.

The radio resource control layer processing unit 36 performs a configuration related to an SPS for the terminal apparatus 1. The radio resource control layer processing unit 36 configures a periodicity of an SPS resource (a PDSCH resource), an initiation timing (offset) of the SPS resource (the PDSCH resource), the number of HARQ processes configured for the SPS, an offset used for deriving a HARQ process ID used for the SPS, a value of an RNTI for scheduling of the SPS, and the like. The radio resource control layer processing unit 36 performs a configuration related to the multiple SPSs. Each of the configurations related to the multiple SPSs is indexed.

The radio resource control layer processing unit 36 performs a configuration of carrier aggregation for the terminal apparatus 1. The radio resource control layer processing unit 36 performs a configuration of a serving cell (a secondary cell, a primary secondary cell) as the configuration of the carrier aggregation. The serving cell may be configured with a downlink component carrier. The serving cell may be configured with a downlink component carrier and an uplink component carrier. The radio resource control layer processing unit 36 controls the radio transmission and/or reception unit 30 so as to perform transmission processing by using the downlink component carrier configured in the carrier aggregation configuration for the terminal apparatus 1. The radio resource control layer processing unit 36 controls the radio transmission and/or reception unit 30 so as to perform reception processing by using the uplink component carrier configured in the carrier aggregation configuration for the terminal apparatus 1.

The radio resource control layer processing unit 36 performs a configuration related to the sidelink for the terminal apparatus 1. The radio resource control layer processing unit 36 configures parameters related to the sidelink for the terminal apparatus 1 and notifies the terminal apparatus 1 of the parameters via the radio transmission and/or reception unit 30. As the parameters related to the sidelink, for example, the following information is used.
A configuration of the sidelink BWP
A configuration of a sidelink radio bearer
A configuration of sidelink measurement

The information indicating the configuration of the sidelink BWP includes information indicating a start position of a symbol in a slot used for the sidelink, a length of the symbol, a configuration of a PSBCH, a configuration of a resource pool of the sidelink, and the like. The information indicating the configuration of the PSBCH includes information indicating a parameter used for transmission power control of the PSBCH. The information indicating the configuration of the sidelink resource pool includes information indicating a configuration of a reception resource pool of the sidelink, a configuration of the transmission resource pool of the sidelink, and the like. The configuration of the transmission resource pool of the sidelink includes a configuration of a transmission resource pool for a mode in which the base station apparatus 3 indicates scheduling information to the terminal apparatus 1 (sidelink resource assignment mode 1) and a configuration of a transmission resource pool for a mode in which the terminal apparatus 1 autonomously performs resource selection (sidelink resource assignment mode 2).

The information indicating the configuration of the sidelink resource pool includes information indicating a configuration of the PSCCH, information indicating a configuration of the PSSCH, information indicating a configuration of the PSFCH, information indicating a subchannel size of the sidelink, information indicating a start position of a subchannel of the sidelink, information indicating an MCS table used in the sidelink, information indicating a configuration of a PTRS of the sidelink, information indicating a TDD UL-DL configuration of the sidelink, information indicating the number of PRBs of the sidelink resource pool, information indicating a time resource of the sidelink resource pool, information indicating a parameter for transmission power control of the sidelink, information indicating the maximum number of a reservation PSCCH/PSSCH resource that can be indicated by one SCI, information indicating a reservable set of resource duration, information indicating whether a DM RS of the PSCCH or the PSSCH is used for L1 RSRP measurement in a sensing operation, information indicating a start position of a sensing window, information indicating an end position of the sensing window, information indicating a configuration of sidelink synchronization, and the like.

Information indicating the configuration of the slot may be included in the information indicating the configuration of the sidelink resource pool. Information indicating which of the following slot configurations is applied may be included: one slot configuration being a slot configuration in which the PSCCH can be allocated only in the first half of the slot (the second OFDM symbol or the second and third OFDM symbols); and the other slot configuration being a slot configuration in which the PSCCH can be allocated in the first half of the slot (the second OFDM symbol or the second and third OFDM symbols), or in the second half of the slot (the ninth OFDM symbol, or the ninth and tenth OFDM symbols).

The PSSCH is allocated in the OFDM symbol in which the PSCCH is allocated or the subsequent OFDM symbols. For example, the PSSCH is allocated in the second or the subsequent OFDM symbols in the slot. For example, in a case that the PSCCH is allocated in the first half of a slot, the PSSCH is allocated in the second or the subsequent OFDM symbols in the slot. For example, in a case that the PSCCH is allocated in the second half of a slot, the PSSCH is allocated in the ninth or the subsequent OFDM symbols in the slot.

The information indicating the configuration of the PSCCH includes information indicating the number of symbols in the PSCCH, information indicating the number of RBs included in the PSCCH, information indicating an initial value (ID) of scrambling of the DM RS of the PSCCH, and information indicating the number of bits reserved by a 1^{st} stage SCI.

The information indicating the configuration of the PSSCH includes information indicating a candidate of a β offset used for determining the number of coded modulation symbols of a 2^{nd} stage SCI, information indicating a time domain pattern of the DM RS of the PSSCH, and information indicating a scaling factor for limiting the number of resource elements assigned to the 2^{nd} stage SCI of the PSSCH.

The information indicating the configuration of the PSFCH includes information indicating a set of PRBs used for transmission and/or reception of the PSFCH, information indicating the number of cyclic shift pairs used for the PSFCH transmission that can be multiplexed in one PRB, information indicating the number of PSFCH resources available for multiplexing HARQ-ACK information, information indicating a scrambling ID for sequence hopping of the PSFCH, information indicating duration of the PSFCH resource, and information indicating the minimum time gap between the PSSCH and the PSFCH. A bitmap is used as the information indicating the set of PRBs used for transmission and/or reception of the PSFCH, and each bit indicates whether the PRB corresponding to a bit position is included in the set of PRBs used for the transmission and/or reception of the PSFCH. The information indicating the duration of the PSFCH resource is information indicating an interval between slots in which the PSFCH resources are allocated. For example, information indicating an interval between every one slot, an interval between every two slots, or an interval between every four slots is used.

The information indicating the parameter of the transmission power control of the sidelink includes information indicating a parameter used for the transmission power control based on a sidelink path loss and information indicating a parameter used for the transmission power control based on a downlink path loss.

The information indicating the configuration of the sidelink synchronization includes information indicating whether the configuration of the sidelink synchronization is used for transmission and/or reception of the sidelink synchronization signal in a case that the terminal apparatus 1 is synchronized with a GNSS or whether the configuration of the sidelink synchronization is used for transmission and/or reception of the sidelink synchronization signal in a case that the terminal apparatus 1 is synchronized with the base station apparatus 3, information indicating a type of hysteresis in a case of evaluating the terminal apparatus 1 of a synchronization reference, information indicating the number of sidelink SSB transmissions in one sidelink SSB duration, information indicating the duration and the start position of the sidelink SSB, information indicating the ID of the sidelink synchronization signal, information indicating a threshold value used for determining the transmission of the sidelink synchronization signal, and the like.

Information indicating the configuration of the sidelink radio bearer includes information indicating whether the terminal apparatus 1 becomes a synchronization reference, information indicating a parameter used for detecting the sidelink radio link failure, information indicating a frequency at which the sidelink is used, information indicating a configuration for the sidelink resource assignment mode 1, information indicating a configuration for the sidelink resource assignment mode 2, information indicating whether CSI reporting is used, information indicating a configuration of a scheduling request of the sidelink, information indicating a priority of transmission and/or reception of the sidelink SSB, information indicating an RLC mode, information indicating a configuration of a sidelink logical channel, information indicating a configuration of a sidelink RLC, and the like.

The information indicating the frequency at which the sidelink is used further includes information indicating a subcarrier interval, information indicating a frequency position of the sidelink SSB, information indicating a synchronization priority, and the like.

The information indicating the configuration for the sidelink resource assignment mode 1 includes information indicating an RNTI used by the base station apparatus 3 to scramble a CRC of the DCI format (for example, a DCI format 3_0) including scheduling information for the terminal apparatus 1, information indicating a configuration of a sidelink MAC, and information indicating a configuration of a sidelink Configured Grant. The information indicating the configuration of the sidelink MAC includes information indicating a configuration of a sidelink BSR and information indicating a threshold value used for determining priorities of sidelink transmission and uplink transmission. The information indicating the configuration of the sidelink Configured Grant includes information indicating an ID for identifying the Configured Grant for the sidelink, information indicating a frequency resource of the sidelink Configured Grant, information indicating a time resource of the sidelink Configured Grant, information indicating a HARQ process ID of the sidelink Configured Grant, information indicating a resource used for HARQ-ACK transmission of the sidelink, information indicating duration of the sidelink Configured Grant, information indicating a resource pool to which the sidelink Configured Grant is applied, information indicating a start subchannel of the sidelink Configured Grant, and the like.

The information indicating the configuration for the sidelink resource assignment mode 2 includes information indicating transmission parameters of the PSSCH such as an MCS, a subchannel number, the number of retransmissions, a transmission power parameter, and the like, information indicating a probability used for resource selection, information indicating a threshold value for the RSRP used for the resource selection, and the like.

In the sidelink resource assignment mode 2, the terminal apparatus 1 performs resource selection. In the sidelink resource assignment mode 2, the terminal apparatus 1 performs resource reservation on a per slot basis. A time interval (resource reservation duration) between the first selected resource set and the next reserved resource set is configured for each resource pool. The base station apparatus 3 transmits the RRC signalling including a parameter indicating the time interval to the terminal apparatus 1. The terminal apparatus 1 receives the RRC signalling including the parameter indicating the time interval from the base station apparatus 3. The time interval is also used for a time interval between the reserved resource sets.

The terminal apparatus 1 recognizes a resource acquired by another terminal apparatus 1 from the information included in the received PSCCH (information of the 1^{st} stage SCI), excludes the resource, and selects and reserves a resource to be used by own terminal apparatus 1 from resources that are not recognized as being acquired by another terminal apparatus 1. The terminal apparatus 1 may recognize the resource acquired or reserved by another terminal apparatus 1 from the information of the 2^{nd} stage SCI included in the received PSSCH.

The information indicating the configuration of the sidelink logical channel includes information indicating a sidelink logical channel priority, information indicating a configuration of a scheduling request applicable to the sidelink logical channel, information indicating a bit rate, information indicating a sidelink bucket size duration, information indicating whether a HARQ feedback is applied to the sidelink logical channel, information indicating a subcarrier interval applied to a resource to which the sidelink logical channel is mapped, information indicating the maximum physical channel duration of the resource to which the sidelink logical channel is mapped, information indicating an ID of a sidelink logical channel group, and the like.

The information indicating the configuration of the sidelink measurement includes information indicating a frequency at which the sidelink measurement is performed, information indicating a filter coefficient applied to the sidelink measurement, information indicating an interval at which a result of the sidelink measurement is reported, information indicating a threshold value used for determination to report the sidelink measurement result, information indicating duration used for determination of the report of the sidelink measurement result, and the like.

The terminal apparatus 1 notifies the base station apparatus 3 of information related to the sidelink by the RRC signalling. Information indicating a frequency at which the terminal apparatus 1 is interested in receiving the sidelink communication, information indicating a frequency at which the terminal apparatus 1 is interested in transmitting the sidelink communication, information indicating a parameter requesting a transmission resource of the sidelink, information related to sidelink capability, information indicating a cast type (broadcast, groupcast, or unicast) requesting a sidelink resource, information indicating a Destination Identity, information related to a sidelink QoS, information indicating the RLC mode, information indicating a list of synchronization references used by the terminal apparatus 1, and the like are included.

The radio resource control layer processing unit 36 of the base station apparatus 3 notifies the terminal apparatus 1 of the RRC signalling indicating multiple Destination identities in consideration of the Destination identity requested by the terminal apparatus 1. The terminal apparatus 1 recognizes and configures (memorizes) the Destination identity of a communication destination to which the terminal apparatus 1 performs sidelink transmission by using the resource pool configured by the base station apparatus 3.

The radio transmission and/or reception unit 30 (or radio transmitting unit 30a) performs processing such as encoding and modulation. The radio transmission and/or reception unit 30 (or radio transmitting unit 30a) generates a complex modulation symbol by encoding and modulating downlink data. The radio transmission and/or reception unit 30 (or radio transmitting unit 30a) converts the complex modulation symbol on the OFDM symbol into an OFDM-based baseband signal through a conversion into a temporally contiguous signal. The radio transmission and/or reception unit 30 (or radio transmitting unit 30a) transmits the baseband signal to the terminal apparatus 1 via a radio frequency. The radio transmission and/or reception unit 30 (or radio transmitting unit 30a) may map the baseband signal to a component carrier.

The radio transmission and/or reception unit 30 (or radio receiving unit 30b) performs processing such as demodulation and decoding. The radio transmission and/or reception unit 30 (or radio transmitting unit 30a) separates, demodulates, and decodes the received signal, and provides the decoded information to the higher layer processing unit 34. The radio transmission and/or reception unit 30 (or radio receiving unit 30b) may perform sensing of a channel prior to the transmission of a signal.

The RF unit 32 demodulates (downconverts) a signal received through the antenna unit 31 into a baseband signal, and/or removes an unnecessary frequency component. The RF unit 32 provides a processed analog signal to the baseband unit 33.

The baseband unit 33 converts the analog signal input from the RF unit 32 into a digital signal. The baseband unit 33 separates a portion corresponding to the CP from the digital signal. The baseband unit 33 applies a fast Fourier transform (FFT) to the digital signal from which the CP is removed. The baseband unit 33 provides a frequency domain signal.

The baseband unit 33 performs inverse fast Fourier transform (IFFT) on downlink data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33, upconverts the analog signal to a carrier frequency, and transmits the up-converted signal through the antenna unit 31. The RF unit 32 may have a function of controlling transmission power. The RF unit 32 is also referred to as a transmission power control unit.

At least one or multiple serving cells (or one or multiple component carriers, one or multiple downlink component carriers, one or multiple uplink component carriers, or one or multiple sidelink component carriers) may be configured in the terminal apparatus 1.

Each serving cell set to the terminal apparatus 1 may be any one of a primary cell (PCell), a primary SCG cell (PSCell), and a secondary cell (SCell).

The PCell is a serving cell included in a Master Cell Group (MCG). The PCell is a cell in which an initial connection establishment procedure or a connection re-establishment procedure is performed by the terminal apparatus 1.

The PSCell is a serving cell included in a Secondary Cell Group (SCG). The PSCell is a cell in which random access is performed by the terminal apparatus 1 in a reconfiguration procedure with synchronization (Reconfiguration with synchronization).

The SCell may be included in either of the MCG or the SCG.

One serving cell group (cell group) is a term including at least the MCG and the SCG. The serving cell group may include one or multiple serving cells (or one or multiple component carriers). The one or multiple serving cells (or one or multiple component carriers) included in one serving cell group may be operated by means of carrier aggregation.

One or multiple downlink BWPs may be configured for each of the serving cells (or downlink component carrier). One or multiple uplink BWPs may be configured for each of the serving cells (or uplink component carrier). One or multiple sidelink BWPs may be configured for each of the serving cells (or sidelink component carrier).

Among one or multiple downlink BWPs for one serving cell (or downlink component carrier), one downlink BWP may be set as an active downlink BWP (one downlink BWP may be activated). Among one or multiple uplink BWPs for one serving cell (or uplink component carrier), one uplink BWP may be set as an active uplink BWP (one uplink BWP may be activated). Among one or multiple sidelink BWPs for one serving cell (or sidelink component carrier), one sidelink BWP may be set as an active sidelink BWP (one sidelink BWP may be activated).

The PDSCH, the PDCCH, the CSI-RS, and another physical downlink channel/signal may be received in the active downlink BWP. The terminal apparatus 1 may receive the PDSCH, the PDCCH, and the CSI-RS in the active downlink BWP. In addition, in some cases, the terminal apparatus 1 may receive the CSI-RS or another downlink channel/signal (for example, a Positioning RS (PRS)) in a downlink BWP that is not active or in a cell that is not a serving cell. A PUSCH, a PUCCH, an SRS, and another physical uplink channel/signal may be transmitted in the active uplink BWP. The terminal apparatus 1 may transmit the PUSCH, the PUCCH, and the SRS in the active uplink BWP. In addition, in some cases, the terminal apparatus 1 may receive the SRS or another downlink channel/signal (for example, positioning SRS) in an uplink BWP that is not active or in a cell that is not a serving cell. Each of the active downlink BWP and the active uplink BWP is also referred to as an active BWP.

Downlink BWP switching deactivates an active downlink BWP, and activates one inactive downlink BWP other than the active downlink BWP. The downlink BWP switching may be controlled by a BWP field that is included in downlink control information. The downlink BWP switching may be controlled based on the higher layer parameter.

Uplink BWP switching deactivates an active uplink BWP, and activates one inactive uplink BWP other than the active uplink BWP. The uplink BWP switching may be controlled by a BWP field that is included in the downlink control information. The uplink BWP switching may be controlled based on the higher layer parameter.

Among one or multiple downlink BWPs for one serving cell, two or more downlink BWPs are not simultaneously set as the active downlink BWP. For one serving cell, at a certain time, one downlink BWP may be active.

Among one or multiple uplink BWPs for one serving cell, two or more uplink BWPs are not simultaneously set as the active uplink BWP. For one serving cell, at a certain time, one uplink BWP may be active.

The procedure for the uplink BWP described above may be applicable to the sidelink BWP.

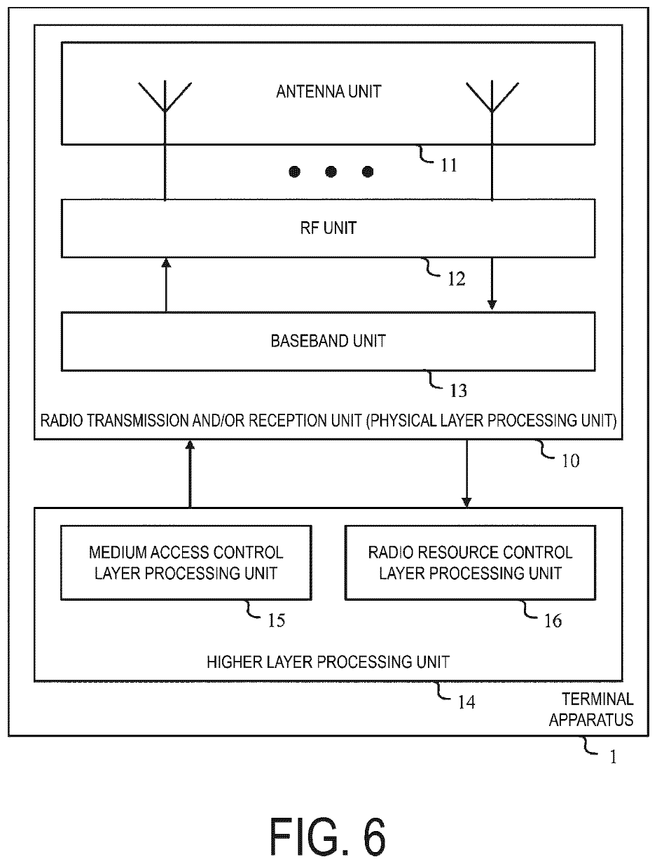

FIG. 6 is a block diagram illustrating a configuration example of the terminal apparatus 1. As illustrated in FIG. 6, the terminal apparatus 1 at least includes a part or all of a radio transmission and/or reception unit (physical layer processing unit) 10 and a higher layer processing unit 14. The radio transmission and/or reception unit 10 at least includes a part or all of an antenna unit 11, an RF unit 12, and a baseband unit 13. The higher layer processing unit 14 at least includes a part or all of a medium access control layer processing unit 15 and a radio resource control layer processing unit 16.

The radio transmission and/or reception unit 10 includes at least a part or all of a radio transmitting unit 10a and a radio receiving unit 10b. A configuration of the baseband unit 13 included in the radio transmitting unit 10a and a configuration of the baseband unit 13 included in the radio receiving unit 10b may be the same or different from each other. A configuration of the RF unit 12 included in the radio transmitting unit 10a and a configuration of the RF unit 12 included in the radio receiving unit 10b may be the same or different from each other. A configuration of the antenna unit 11 included in the radio transmitting unit 10a and a configuration of the antenna unit 11 included in the radio receiving unit 10b may be the same or different from each other.

The radio transmission and/or reception unit 10 performs processing of the physical layer.

For example, the radio transmission and/or reception unit 10 may generate a baseband signal of an uplink physical channel. Here, the transport block delivered by the higher layer on a UL-SCH may be mapped to the uplink physical channel. For example, the radio transmission and/or reception unit 10 may generate a baseband signal of an uplink physical signal.

For example, the radio transmission and/or reception unit 10 may attempt to detect information communicated by a downlink physical channel. Here, a transport block included in the information communicated by the downlink physical channel may be delivered to the higher layer on a DL-SCH. For example, the radio transmission and/or reception unit 10 may attempt to detect information communicated by a downlink physical signal.

For example, the radio transmission and/or reception unit 10 may generate a baseband signal of a sidelink physical channel. For example, the radio transmission and/or reception unit 10 may generate a baseband signal of a sidelink physical signal. For example, the radio transmission and/or reception unit 10 may attempt to detect information communicated by the sidelink physical channel. For example, the radio transmission and/or reception unit 10 may attempt to detect information communicated by the sidelink physical signal.

The radio transmission and/or reception unit 10 (or radio receiving unit 10b) receives the PDCCH. The radio transmission and/or reception unit 10 (or radio receiving unit 10b) performs processing of receiving the PDCCH in the downlink frequency band (cell, component carrier, carrier). The radio transmission and/or reception unit 10 (or radio receiving unit 10b) performs processing such as demodulation and decoding for the PDCCH. The radio transmission and/or reception unit 10 (or radio receiving unit 10b) performs processing of receiving the PDCCH and processing of detecting the downlink control information.

The radio transmission and/or reception unit 10 (or radio receiving unit 10b) receives the PDSCH. The radio transmission and/or reception unit 10 (or radio receiving unit 10b) performs processing of receiving the PDSCH in the downlink frequency band (cell, component carrier, carrier). The radio transmission and/or reception unit 10 (or radio receiving unit 10b) performs processing such as demodulation and decoding for the PDSCH.

The radio transmission and/or reception unit 10 (or radio receiving unit 10b) receives the PSCCH. The radio transmission and/or reception unit 10 (or radio receiving unit 10b) performs processing such as demodulation and decoding for the PSCCH. The radio transmission and/or reception unit 10 (or radio receiving unit 10b) performs processing of receiving the PSCCH and processing of detecting sidelink control information. The radio receiving unit 10b determines a frequency resource (interlace and resource block described below) included in the PSCCH. The receiving unit of the terminal apparatus 1 determines the OFDM symbol in which the PSCCH can be allocated. The radio transmission and/or reception unit 10 (or radio receiving unit 10b) blind-decodes the PSCCH. The radio transmission and/or reception unit 10 (or radio receiving unit 10b) blind-decodes the PSCCH in one slot in one resource pool. The radio transmission and/or reception unit 10 (or radio receiving unit 10b) may blind-decode the PSCCH in two or more slots in one resource pool. The radio transmission and/or reception unit 10 (or radio receiving unit 10b) may blind-decode two or more PSCCHs in one slot in one resource pool. The radio transmission and/or reception unit 10 (or radio receiving unit 10b) receives the PSSCH. The radio transmission and/or reception unit 10 (or radio receiving unit 10b) performs processing such as demodulation and decoding for the PSSCH. The receiving unit of the terminal apparatus 1 receives the PSFCH. The radio transmission and/or reception unit 10 (or radio receiving unit 10b) receives the HARQ-ACK with the PSFCH

The radio transmission and/or reception unit 10 (or radio transmitting unit 10a) transmits the HARQ-ACK. The radio transmission and/or reception unit 10 (or radio transmitting unit 10a) transmits the HARQ-ACK for the PDSCH. The radio transmission and/or reception unit 10 (or radio transmitting unit 10a) transmits the HARQ-ACK in the uplink frequency band (cell, component carrier, carrier).

The radio transmission and/or reception unit 10 (or radio transmitting unit 10a) transmits the HARQ-ACK for the PSSCH. The radio transmission and/or reception unit 10 (or radio transmitting unit 10a) transmits the HARQ-ACK in a sidelink frequency band. The radio transmission and/or reception unit 10 (or radio transmitting unit 10a) transmits the HARQ-ACK with the PSFCH. The radio transmission and/or reception unit 10 (or radio transmitting unit 10a) may transmit the HARQ-ACK with the PSSCH. The radio transmission and/or reception unit 10 (or radio transmitting unit 10a) need not transmit the HARQ-ACK for the PSSCH.

The radio transmission and/or reception unit 10 (or radio transmitting unit 10a) transmits the PSCCH. The radio transmission and/or reception unit 10 (or radio transmitting unit 10a) performs processing such as encoding and modulation for the PSCCH. The radio transmission and/or reception unit 10 (or radio transmitting unit 10a) performs processing of transmitting sidelink control information (1^{st} stage SCI) by using the PSCCH. The radio transmission and/or reception unit 10 (or radio transmitting unit 10a) determines frequency resources (interlace and resource block described below) constituting the PSCCH. The radio transmission and/or reception unit 10 (or radio transmitting unit 10a) determines the OFDM symbol in which the PSCCH can be allocated. The radio transmission and/or reception unit 10 (or radio transmitting unit 10a) transmits the PSSCH. The radio transmission and/or reception unit 10 (or radio transmitting unit 10a) performs processing such as encoding and modulation for the PSSCH. The radio transmission and/or reception unit 10 (or radio transmitting unit 10a) performs processing of transmitting sidelink control information (2^{nd} stage SCI) by using the PSSCH. Information such as the MAC CE is transmitted by using the PSSCH.

The radio transmission and/or reception unit 10 performs carrier sensing (LBT) before transmission of a signal in order to avoid contention of the signal with another device (apparatus). As types of the LBT, the following types are used.
Type 1: LBT performing a random backoff process by using a contention window having a variable size
Type 2A: LBT performing 25 us carrier sensing before signal transmission, without the random backoff process
Type 2B: LBT performing 16 us carrier sensing before signal transmission, without the random backoff process
Type 2C: no LBT performed

The radio transmission and/or reception unit 10 transmits a signal after it is detected that there is no transmission from another device in listening (idle state), and does not transmit a signal in a case that it is detected that there is transmission from another device in the listening (busy state). In a case that the LBT result is idle, the radio transmission and/or reception unit 10 acquires a transmission opportunity and performs transmission, and in a case that the LBT result is busy, the radio transmission and/or reception unit 10 does not perform transmission. The time of the transmission opportunity is referred to as Channel Occupancy Time (COT). In the LBT, the terminal apparatus 1 monitors a channel before transmitting data, evaluates an idle channel, and transmits data in a case that it is confirmed that the channel is in the idle state.

In a case that the random backoff process is performed, the radio transmission and/or reception unit 10 randomly generates, after the previous transmission, a backoff counter value in a range of a contention window size. In the random backoff, the terminal apparatus 1 evaluates whether the channel is in the idle state by detecting channel energy at each time interval by the random backoff counter. The radio transmission and/or reception unit 10 awaits until it is confirmed that the channel is idle for a certain period of time, and performs carrier sensing (sensing) in each sensing slot time. In a case that the channel is idle as a result of the carrier sensing, the radio transmission and/or reception unit 10 decrements the backoff counter value. In a case that the channel is busy as a result of the carrier sensing, the radio transmission and/or reception unit 10 maintains the backoff counter value and, after awaiting until it is confirmed that the channel is idle for a certain period of time, performs the carrier sensing. As a result of repeating the above operation, after the backoff counter value becomes 0, the radio transmission and/or reception unit 10 obtains an access privilege to a channel and can initiate transmission of a signal on the channel.

In a case that the HARQ-ACK feedback is applied to the sidelink, the radio transmission and/or reception unit 10 updates the contention window size based on the status of the HARQ-ACK. In a case that the status of the HARQ-ACK is ACK, the radio transmission and/or reception unit 10 configures the contention window size to the minimum value. In a case that the status of the HARQ-ACK is NACK, the radio transmission and/or reception unit 10 configures the contention window size to the next large value. In a case that the contention window size reaches the maximum value that can be configured, the radio transmission and/or reception unit 10 continues to use the maximum value even in a case of the status of the HARQ-ACK being the NACK. In a case that the contention window size of the maximum value is continuously used a prescribed number of times, the radio transmission and/or reception unit 10 may configure (may reset) the contention window size to the minimum value. The prescribed number of times may be configured by the base station apparatus 3 to the terminal apparatus 1.

The initial value of the random backoff counter may be an integer between 0 and the contention window size. By adjusting the contention window size before the random backoff counter is initialized, average time required for the terminal apparatus 1 to access the channel is controlled.

The terminal apparatus 1 performs the Listen Before Talk (LBT) on the channel before transmission on the channel. The terminal apparatus 1 may adjust the time duration (amount of time) in which the LBT is performed. The terminal apparatus 1 can select a random number between zero and the contention window size. In a case that the channel is free for at least the time duration associated with the selected random number, the terminal apparatus 1 can obtain a transmission opportunity and perform transmission.

The higher layer processing unit 14 provides the uplink data or the sidelink data to the radio transmission and/or reception unit 10 (or the radio transmitting unit 10a). The higher layer processing unit 14 performs processing of the MAC layer, a PDCP layer, an RLC layer, and/or the RRC layer. The higher layer processing unit 14 may perform processing of the MAC layer, the PDCP layer, the RLC layer, and/or the RRC layer in the PC5.

The medium access control layer processing unit 15 included in the higher layer processing unit 14 performs processing of the MAC layer.

The medium access control layer processing unit (MAC layer processing unit) 15 performs processing of a sidelink HARQ operation, a sidelink scheduling request, a sidelink buffer status report, and a CSI report.

The radio resource control layer processing unit 16 included in the higher layer processing unit 14 performs processing of the RRC layer and/or a PC5-RRC (PC5 RRC). The radio resource control layer processing unit 16 manages various pieces of configuration information/parameters (RRC parameters) and/or PC5-RRC parameters of the terminal apparatus 1. The radio resource control layer processing unit 16 configures the RRC parameters and/or the PC5-RRC parameters based on the RRC message received from the base station apparatus 3 and/or the PC5-RRC message received from another terminal apparatus,

For example, the radio resource control layer processing unit 16 may acquire the RRC parameter included in the RRC message on a certain logical channel and set the acquired RRC parameter in a storage area of the terminal apparatus 1. The RRC parameter set in the storage area of the terminal apparatus 1 may be provided to a lower layer.

The radio resource control layer processing unit 16 configures a control resource set based on an RRC signalling received from the base station apparatus 3. The radio resource control layer processing unit 16 configures a search space in the control resource set. The radio resource control layer processing unit 16 configures a PDCCH candidate to be monitored in the control resource set. The radio resource control layer processing unit 16 configures the number of the PDCCH candidates to be monitored in the control resource set. The radio resource control processing unit 16 configures an Aggregation level of the PDCCH candidate to be monitored in the control resource set.

The radio resource control layer processing unit 16 configures a DCI format to be monitored in the control resource set. The radio resource control layer processing unit 16 may configure the DCI format to be monitored in the search space. The radio resource control layer processing unit 16 configures the DCI format to be monitored in the control resource set based on the RRC signalling indicated by the base station apparatus 3. The radio resource control layer processing unit 16 may configure the DCI format to be monitored in the search space based on the RRC signalling indicated by the base station apparatus 3. The radio resource control layer processing unit 16 configures one or more DCI formats to be monitored by the radio transmission and/or reception unit 10 (or radio receiving unit 10a).

The radio resource control layer processing unit 16 performs configuration related to the sidelink based on the RRC signalling received from the base station apparatus 3. The radio resource control layer processing unit 16 configures a parameter related to the sidelink provided as notification by the base station apparatus 3. The parameter related to the sidelink will be described below. For example, the radio resource control layer processing unit 16 configures an OFDM symbol in which the PSCCH can be allocated. For example, the radio resource control layer processing unit 16 configures a band in which the PSCCH is allocated. For example, the radio resource control layer processing unit 16 configures a resource block constituting one PSCCH or the number of the interlaces. The radio resource control layer processing unit 16 performs configuration related to transmission and/or reception of the PSCCH for the radio transmission and/or reception unit 10. For example, the radio resource control layer processing unit 16 configures a slot in which the PSFCH can be transmitted. For example, a slot in which the PSFCH can be transmitted is configured every four slots.

The radio resource control layer processing unit 16 configures one or more Destination identities of the unicast and the groupcast communication destinations. The groupcast is communication between multiple terminal apparatuses 1, and multiple Destination identities are configured.

The radio transmission and/or reception unit 10 (or radio transmitting unit 10a) performs processing such as encoding and modulation. The radio transmission and/or reception unit 10 (or radio transmitting unit 10a) generates a complex modulation symbol by encoding and modulating uplink and/or sidelink data. The radio transmission and/or reception unit 10 (or radio transmitting unit 10a) converts the complex modulation symbol on the OFDM symbol into an OFDM-based baseband signal through a conversion into a temporally contiguous signal. The radio transmission and/or reception unit 10 (or radio transmitting unit 10a) transmits the baseband signal to the base station apparatus 3 or another terminal apparatus via a radio frequency. The radio transmission and/or reception unit 10 (or radio transmitting unit 10a) may map the baseband signal to a component carrier.

The radio transmission and/or reception unit 10 (or radio receiving unit 10b) performs processing such as demodulation and decoding. The radio transmission and/or reception unit 10 (or radio receiving unit 10b) may receive a BWP (active downlink BWP) of a serving cell and/or a physical signal in the sidelink BWP. The radio transmission and/or reception unit 10 (or radio receiving unit 10b) separates, demodulates, and decodes a received signal and provides the decoded information to the higher layer processing unit 14. The radio transmission and/or reception unit 10 (or radio receiving unit 10b) may perform sensing of a channel prior to the transmission of a signal.

The RF unit 12 demodulates (downconverts) a signal received through the antenna unit 11 into a baseband signal, and/or removes an unnecessary frequency component. The RF unit 12 provides a processed analog signal to the baseband unit 13.

The baseband unit 13 converts the analog signal input from the RF unit 12 into a digital signal. The baseband unit 13 separates a portion corresponding to the CP from the digital signal. The baseband unit 13 applies a fast Fourier transform (FFT) to the digital signal from which the CP is removed. The baseband unit 13 provides a frequency domain signal.

The baseband unit 13 performs inverse fast Fourier transform (IFFT) on uplink or sidelink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes an unnecessary frequency component from the analog signal input from the baseband unit 13, upconverts the analog signal to a carrier frequency, and transmits the up-converted signal through the antenna unit 11. The RF unit 12 may have a function of controlling transmission power. The RF unit 12 is also referred to as a transmission power control unit.

Here, the physical signal (also referred to as a signal) will be described.

The physical signal is a general term for the downlink physical channel, the downlink physical signal, the uplink physical channel, the uplink physical signal, the sidelink physical channel, and the sidelink physical signal.

The uplink physical channel may correspond to information originating from the higher layer (information provided by the higher layer) and/or a set of resource elements for conveying uplink control information. The uplink physical channel may be a physical channel used in the uplink component carrier. The uplink physical channel may be transmitted by the terminal apparatus 1. The uplink physical channel may be received by the base station apparatus 3. In the radio communication system according to an aspect of the present embodiment, at least a part or all of the physical uplink control channel (PUCCH), the physical uplink shared channel (PUSCH), and a physical random access channel (PRACH) may be used.

The PUCCH may be used to transmit Uplink Control Information (UCI). The PUCCH may be sent for delivering (transmitting, conveying) the uplink control information. The uplink control information may be mapped (arranged) to the PUCCH. The terminal apparatus 1 may transmit the PUCCH to which the uplink control information is mapped. The radio transmission and/or reception unit 30 of the base station apparatus 3 may receive the PUCCH to which the uplink control information is mapped.

The uplink control information (an uplink control information bit, an uplink control information sequence, and an uplink control information type) includes at least a part or all of Channel State Information (CSI), a Scheduling Request (SR), and the Hybrid Automatic Repeat reQuest-ACKnowledgement (HARQ-ACK).

The channel state information is conveyed by using a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include a HARQ-ACK status corresponding to a Transport Block (TB, a MAC Protocol Data Unit (MAC PDU), a Downlink Shared Channel (the DL-SCH), and an Uplink Shared Channel (the UL-SCH)). The HARQ-ACK status may include the Acknowledge (ACK) and the Negative-acknowledge (NACK) corresponding to the transport block. The ACK may indicate that the transport block is correctly decoded. The NACK may indicate that the transport block is not correctly decoded. The HARQ-ACK information may include a HARQ-ACK codebook including one or multiple HARQ-ACK statuses (or HARQ-ACK bits).

For example, the relationship between the HARQ-ACK information and the transport block may mean the relationship between the HARQ-ACK information and the PDSCH used for transmission of the corresponding transport block.

The HARQ-ACK status may indicate the ACK or the NACK corresponding to one Code Block Group (CBG) included in the transport block.

The scheduling request may be used at least to request the PUSCH (or the UL-SCH) resource for new transmission. The scheduling request may be used to indicate either a positive SR or a negative SR. The scheduling request indicating the positive SR may be referred to as the positive SR being sent. The positive SR may indicate that the PUSCH (or the UL-SCH) resource for initial transmission is requested by the terminal apparatus 1. The positive SR may indicate that the higher layer triggers the scheduling request. The positive SR may be transmitted in a case that the higher layer indicates to transmit the scheduling request. That the scheduling request bit indicates the negative SR may be referred to as that the negative SR is sent. The negative SR may indicate that the PUSCH (or the UL-SCH) resource for initial transmission is not requested by the terminal apparatus 1. The negative SR may indicate that the higher layer does not trigger the scheduling request. The negative SR may be transmitted in a case that the higher layer does not indicate to transmit the scheduling request.

The channel state information may include at least a part or all of a Channel Quality Indicator (CQI), a Precoder Matrix Indicator (PMI), and a Rank Indicator (RI). The CQI is an indicator related to channel quality (for example, propagation quality) or quality of a physical channel, and the PMI is an indicator related to a precoder. The RI is an indicator related to a transmission rank (or the number of transmission layers).

The channel state information may be provided at least based on reception of one or multiple physical signals (for example, one or multiple CSI-RSs) at least used for channel measurement. The channel state information may be selected by the terminal apparatus 1 at least based on reception of one or multiple physical signals used for the channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH format may include the UCI

The PUSCH may be used for transmitting the uplink data (the transport block) and/or the uplink control information. The PUSCH may be used for transmitting the uplink data (the transport block) corresponding to the UL-SCH and/or the uplink control information. The PUSCH may be used for conveying the uplink data (the transport block) and/or the uplink control information. The PUSCH may be used for conveying the uplink data (the transport block) corresponding to the UL-SCH and/or the uplink control information. The uplink data (the transport block) may be mapped to the PUSCH. The uplink data (the transport block) corresponding to the UL-SCH may be mapped to the PUSCH. The uplink control information may be mapped to the PUSCH. The terminal apparatus 1 may transmit the uplink data (the transport block) and/or the PUSCH to which the uplink control information is mapped. The base station apparatus 3 may receive the uplink data (the transport block) and/or the PUSCH to which the uplink control information is mapped.

The PRACH may be used for transmitting a random access preamble. The PRACH may be used for conveying a random access preamble. A PRACH sequence x_{u,v}(n) may be defined as x_{u,v}(n)=(mod(n+Cᵥ, L_{RA})). xᵤ may be a Zadoff-Chu (ZC) sequence. xu may be defined as xᵤ=exp(−jpui(i+1)/L_{RA}). j is an imaginary unit. p is the ratio of the circumference of a circle to its diameter. Cᵥ corresponds to a cyclic shift of the PRACH. L_{RA} corresponds to a length of the PRACH. L_{RA} may be 839, 139, or some other value, i is an integer in a range from 0 to L_{RA}−1. u is a sequence index for the PRACH. The terminal apparatus 1 may transmit the PRACH. The base station apparatus 3 may receive the PRACH.

For a certain PRACH opportunity, 64 random access preambles are defined. The random access preambles are specified (determined, given) at least based on the cyclic shift Cᵥ of the PRACH and the sequence index u of the PRACH.

The uplink physical signal may correspond to a set of resource elements. The uplink physical signal does not convey information generated in the higher layer. The uplink physical signal may be the physical signal used in the uplink component carrier. The terminal apparatus 1 may transmit the uplink physical signal. The base station apparatus 3 may receive the uplink physical signal. In the radio communication system according to an aspect of the present embodiment, at least a part or all of an uplink demodulation reference signal (UL DMRS), a sounding reference signal (SRS), and an uplink phase-tracking reference signal (UL PTRS) may be used. The SRS may be used for positioning.

A set of antenna ports of the DMRS for the PUSCH (the DMRS related to the PUSCH, the DMRS included in the PUSCH, or the DMRS corresponding to the PUSCH) may be given based on a set of antenna ports of the PUSCH. That is, the set of antenna ports of the DMRS for the PUSCH may be the same as the set of antenna ports for the PUSCH.

Transmission of the PUSCH and transmission of the DMRS for the PUSCH may be indicated (scheduled) by one DCI format. The PUSCH and the DMRS for the PUSCH may be collectively referred to as the PUSCH. Transmission of the PUSCH may be transmission of the PUSCH and the DMRS for the PUSCH.

The PUSCH may be inferred from the DMRS for the PUSCH. That is, a channel of the PUSCH may be inferred from the DMRS for the PUSCH.

A set of antenna ports of the DMRS for the PUCCH (a DMRS related to the PUCCH, a DMRS included in the PUCCH, or a DMRS corresponding to the PUCCH) may be the same as a set of antenna ports of the PUCCH.

Transmission of the PUCCH and transmission of the DMRS for the PUCCH may be indicated (triggered) by one DCI format. The allocation of the PUCCH in the resource element and/or the mapping of the DMRS in the resource element for the PUCCH may be provided at least by one PUCCH format. The PUCCH and the DMRS for the PUCCH may collectively be referred to as the PUCCH. Transmission of the PUCCH may be transmission of the PUCCH and the DMRS for the PUCCH.

The PUCCH may be inferred from the DMRS for the PUCCH. That is, a channel of the PUCCH may be inferred from the DMRS for the PUCCH.

The downlink physical channel may correspond to information originating from the higher layer (information provided by the higher layer) and/or a set of resource elements for conveying the downlink control information. The downlink physical channel may be a physical channel used in a downlink component carrier. The base station apparatus 3 may transmit a downlink physical channel. The terminal apparatus 1 may receive a downlink physical channel. In the radio communication system according to an aspect of the present embodiment, at least a part or all of a Physical Broadcast CHannel (PBCH), a Physical Downlink Control CHannel (the PDCCH), and a Physical Downlink Shared CHannel (the PDSCH) may be used.

The PBCH may be used for transmitting a Master Information Block (MIB) and/or physical layer control information. The physical layer control information is a certain type of the downlink control information. The PBCH may be sent for delivering the MIB and/or the physical layer control information. A Broadcast CHannel (BCH) may be mapped to the PBCH. The terminal apparatus 1 may receive the PBCH. The base station apparatus 3 may transmit the PBCH. The physical layer control information may also be referred to as a PBCH payload and a PBCH payload related to timing. The MIB may include one or multiple higher layer parameters.

The physical layer control information includes 8 bits. The physical layer control information may include at least a part or all of the following 0A to 0D. The 0A is radio frame information. The 0B is half radio frame information (half system frame information). The 0C is SS/PBCH block index information. The 0D is subcarrier offset information.

The radio frame information is used to specify a radio frame in which the PBCH is transmitted (radio frame including the slot in which the PBCH is transmitted). The radio frame information is represented by 4 bits. The radio frame information may be represented by 4 bits of a radio frame indicator. The radio frame indicator may include 10 bits. For example, the radio frame indicator may at least be used to specify a radio frame of from index 0 to index 1023.

The half radio frame information is used to specify whether, in the radio frame in which the PBCH is transmitted, the PBCH is transmitted in the first 5 subframes or transmitted in the second 5 subframes. Here, the half radio frame may include five subframes. The half radio frame may include five subframes in the first half of 10 subframes included in one radio frame. The half radio frame may include five subframes in the second half of 10 subframes included in one radio frame.

SS/PBCH block index information is used to specify an SS/PBCH block index. The SS/PBCH block index information may be represented by 3 bits. The SS/PBCH block index information may include 3 bits of a SS/PBBCH block index indicator. The SS/PBCH block index indicator may include 6 bits. The SS/PBCH block index indicator may at least be used to specify the SS/PBCH block from index 0 to index 63 (or from index 0 to index 3, from index 0 to index 7, from index 0 to index 9, from index 0 to index 19, or the like).

The subcarrier offset information is used to specify a subcarrier offset. The subcarrier offset information may be used to specify a difference between the leading subcarrier to which the PBCH is allocated and the leading subcarrier to which the control resource set with the index 0 is allocated.

The PDCCH may be used for transmitting a Downlink Control Information (DCI). The PDCCH may be transmitted for delivering the DCI The DCI may be mapped on the PDCCH The terminal apparatus 1 may receive the PDCCH to which the DCI is mapped. The base station apparatus 3 may transmit the PDCCH to which the DCI is mapped.

The DCI may correspond to the DCI format. The DCI may be included in the DCI format. The DCI may be mapped to each field of the DCI format.

The DCI format is a general term for a DCI format 0_0, a DCI format 0_1, a DCI format 1_0, a DCI format 1_1, a DCI format 3_0, a DCI format 3_1, and the like. An uplink DCI format is a general term for the DCI format 0_0 and the DCI format 0_1, and the like. A downlink DCI format is a general term for the DCI format 1_0 and the DCI format 1_1, and the like. A sidelink DCI format is a general term for the DCI format 3_0 and the DCI format 3_1, and the like.

The PDSCH may be used for transmitting one or multiple transport blocks. The PDSCH may be used for transmitting one or multiple transport blocks corresponding to the DL-SCH. The PDSCH may be used for delivering one or multiple transport blocks. The PDSCH may be used for delivering one or multiple transport blocks corresponding to the DL-SCH. One or multiple transport blocks may be mapped to one PDSCH. One or multiple transport blocks corresponding to the DL-SCH may be mapped to one PDSCH. The base station apparatus 3 may transmit the PDSCH. The terminal apparatus 1 may receive the PDSCH.

The downlink physical signal may correspond to a set of resource elements. The downlink physical signal need not convey information generated in the higher layer. The downlink physical signal may be a physical signal used in the downlink component carrier. The downlink physical signal may be transmitted by the base station apparatus 3. The downlink physical signal may be received by the terminal apparatus 1. In the radio communication system according to an aspect of the present embodiment, at least a part or all of a Synchronization Signal (SS), a DownLink DeModulation Reference Signal (DL DMRS), a Channel State Information Reference Signal (CSI-RS), a DownLink Phase-Tracking Reference Signal (DL PTRS), and a Positioning Reference Signal (PRS) may be used.

The PRS may be referred to as a DL PRS. The PRS may be used to measure a position of the terminal apparatus 1 in positioning via the Uu interface. For example, the PRS may be used in a positioning method such as a DL-TDOA, a DL-AoD, a Multi-RTT, or the like.

The synchronization signal may be used at least for the terminal apparatus 1 to synchronize in a frequency domain and/or a time domain for a downlink. The synchronization signal is a general term for a Primary Synchronization Signal (PSS) and a Secondary Synchronization Signal (SSS).

The sidelink physical channel may correspond to a set of resource elements conveying information generated in the higher layer. The sidelink physical channel is a physical channel used in a sidelink. The sidelink physical channel may be transmitted by the radio transmission and/or reception unit 10. The sidelink physical channel may be received by the radio transmission and/or reception unit 10. In the radio communication system according to an aspect of the present embodiment, at least a part or all of the following sidelink physical channels are used.
Physical Sidelink Broadcast CHannel (PSBCH)
Physical Sidelink Control CHannel (PSCCH)
Physical Sidelink Shared CHannel (PSSCH)
Physical Sidelink Feedback CHannel (PSFCH)

The PSBCH is transmitted in order to communicate a Direct Frame Number (DFN), a TDD UL-DL configuration, a slot index (slot index of a slot in which the PSBCH is allocated), and an in-coverage indicator (an identifier indicating whether the transmission terminal apparatus 1 is positioned inside the coverage of the base station apparatus 3).

The PSCCH is at least used to transmit (communicate) the Sidelink Control Information (SCI). The sidelink control information may be mapped to the PSCCH. The terminal apparatus 1 may receive the PSCCH to which the sidelink control information is mapped. The terminal apparatus 1 may transmit the PSCCH to which the sidelink control information is mapped.

The sidelink control information is transmitted and/or received in the form of a sidelink control information format (SCI format). The SCI transmitted and/or received in the PSCCH is referred to as the 1^{st} stage SCI The SCI transmitted and/or received in the PSSCH is referred to as the 2^{nd} stage SCI. An SCI format 1-A may be included in a 1^{st} stage SCI format. The SCI format 1-A is used for scheduling of the PSSCH and the 2^{nd} stage SCI. The SCI format 1-A includes a field indicating priority, a field indicating frequency-resource assignment, a field indicating time-resource assignment, a field indicating resource reservation duration, a field indicating a DMRS pattern, a field indicating a 2^{nd} stage SCI format (SCI format 2-A, SCI format 2-B, and SCI format 2-C), a field indicating a beta offset (parameter used for determining resource amount of the 2^{nd} stage SCI), a field indicating the number of DMRS ports, a field indicating the MCS, a field indicating the MCS table, a field including a PSFCH overhead indication, a Reserved field, and information indicating whether to receive contention information.

The 2^{nd} stage SCI is used for decoding the PSSCH. The SCI format 2-A includes a HARQ process number, an NDI, a Redundancy version (RV), a Source ID, a Destination ID, a HARQ feedback enable/disable indicator, a cast type indicator (unicast, broadcast, or groupcast), and information of a CSI request. The SCI format 2-B includes the HARQ process number, the NDI, the RV, the Source ID, the Destination ID, the HARQ feedback enable/disable indicator, a Zone ID, and information on a communication range request. The SCI format 2-C includes the HARQ process number, the NDI, the RV, the Source ID, the Destination ID, the HARQ feedback enable/disable indicator, the information of the CSI request, and a Providing/Requesting indicator.

The PSSCH may be transmitted to communicate sidelink data (sidelink transport block and sidelink PDU) and the 2^{nd} stage SCI. The PSSCH may be used to communicate the sidelink data and the 2^{nd} stage SCI The terminal apparatus 1 may transmit the PSSCH to which the sidelink data and the 2^{nd} stage SCI are mapped. The terminal apparatus 1 may receive the PSSCH to which the sidelink data and the 2^{nd} stage SCI are mapped.

The PSFCH is used to communicate the HARQ-ACK information corresponding to PSSCH reception. The terminal apparatus 1 transmits the PSFCH to which the HARQ-ACK information is mapped. The terminal apparatus 1 receives the PSFCH to which the HARQ-ACK information is mapped.

The sidelink physical signal may correspond to a set of resource elements. The sidelink physical signal need not be used to communicate information generated in the higher layer. The sidelink physical signal may be used to communicate information generated in the physical layer. The radio transmission and/or reception unit 10 may transmit the sidelink physical signal. The radio transmission and/or reception unit 10 may receive the sidelink physical signal. In the sidelink of the radio communication system according to an aspect of the present embodiment, at least a part or all of the following sidelink physical signals may be used. Sidelink Synchronization Signal (S-SS)
Sidelink DMRS
Sidelink CSI-RS
Sidelink PT-RS
Sidelink PRS (SL-PRS)

The sidelink synchronization signal is used for the terminal apparatus 1 to synchronize in a frequency domain and/or a time domain of the sidelink. The sidelink synchronization signal is a general term for a Sidelink Primary Synchronization Signal (S-PSS) and a Sidelink Secondary Synchronization Signal (S-SSS).

The sidelink DMRS is a general term for the DMRS for the PSBCH, the DMRS for the PSCCH, and the DMRS for the PSSCH. A time domain pattern of the DMRS for the PSSCH is selected by the terminal apparatus 1 on a transmission side. The time domain pattern of a selection candidate is configured for each resource pool.

The sidelink CSI-RS is a reference signal used for channel measurement of the sidelink. The time resource assignment (mapped symbol position) for the CSI-RS, the frequency resource assignment, the number of antenna ports, and the number of layers for the CSI-RS are configured. The terminal apparatus 1 reports the channel state information measured based on the sidelink CSI-RS by using the MAC CE.

The sidelink PT-RS may be supported only in a high frequency band (FR2). Time density and frequency density of the sidelink PT-RS are configured for each resource pool.

The sidelink PRS is a reference signal used to measure the position of the terminal apparatus 1 in the sidelink positioning. Details of the sidelink PRS will be described below.

A signal for an Access Gain Control (AGC) may be used. The signal for the AGC may be mapped in the first OFDM symbol of a slot (a first slot and a second slot).

The terminal apparatus 1 may report, to the base station apparatus 3, information on the HARA-ACK of the sidelink received from a terminal apparatus 1 being a transmission destination, by using the PUCCH of the uplink. A Semi-static HARQ-ACK codebook or a Dynamic HARQ-ACK codebook may be used.

The base station apparatus 3 may notify the terminal apparatus 1 of scheduling information of the sidelink by using the DCI format. The DCI format 3_0 is used for scheduling of the PSCCH and the PSSCH. The DCI format 3_0 includes a part or all of the following information.
Resource pool index
Time gap
HARQ process number
NDI
Subchannel assignment information
SCI format 1-A field
Timing indicator for performing feedback of HARQ-ACK of PSSCH corresponding to PSFCH reception
PUCCH resource indicator
Configuration index
Sidelink assignment index counter

The resource pool index indicates a resource pool used for the PSCCH and the PSSCH to be scheduled. The time gap indicates a time period from receiving the DCI format 3_0 to performing the sidelink transmission. The subchannel assignment information indicates a subchannel used for the PSCCH and the PSSCH to be scheduled. The SCI format 1-A field includes information on the frequency resource assignment and the time resource assignment of the SCI format 1-A that the terminal apparatus 1 transmits on the PSCCH. The timing indicator for performing feedback of the HARQ-ACK of the PSSCH corresponding to the PSFCH reception indicates a timing at which the terminal apparatus 1 performs feedback of the HARQ-ACK information acquired by receiving the PSFCH from a terminal apparatus 1 by using the PUCCH. The PUCCH resource indicator indicates a resource of the PUCCH used for performing feedback of the HARQ-ACK information acquired by receiving the PSFCH. The configuration index indicates a configuration of the sidelink Configured Grant. The sidelink assignment index counter indicates the number of sidelink assignments assigned to the terminal apparatus 1 by the base station apparatus 3 within a certain duration.

The terminal apparatus 1 performs channel sensing (carrier sensing) in order to check the presence or absence of transmission of another device (for example, a base station apparatus, a terminal apparatus, a WiFi terminal apparatus, a WiFi access point, or the like) before signal transmission (channel access). The terminal apparatus 1 randomly generates a backoff counter value within a range of a Contention Window Size (CWS) after the previous signal transmission. The terminal apparatus 1 awaits until it is confirmed that a channel (LBT subband or RB set, band of 20 MHz bandwidth, for example) is idle, and performs the carrier sensing for each sensing slot time. In a case that the channel is idle, the terminal apparatus 1 sequentially decrements the counter value randomly determined within the Contention Window Size (CWS), obtains an access privilege to the channel after the counter value becomes 0, and transmits a signal. The terminal apparatus 1 that performs communication by using the HARQ-ACK feedback updates, after the completion of the signal transmission, the contention window size based on the HARQ-ACK feedback received from a terminal apparatus 1 being the signal transmission destination. In a case that the status of the HARQ-ACK is ACK, the terminal apparatus 1 configures the contention window size to the minimum value. In a case that the status of the HARQ-ACK is NACK, the terminal apparatus 1 configures the contention window size to a next large value. In the case that the contention window size reaches the maximum value that can be configured, the terminal apparatus 1 continues to use the maximum value even in the case that the status of the HARQ-ACK is NACK.

The terminal apparatus 1 acquires a Transmission Opportunity (TxOP, or Channel Occupancy) and performs transmission in a case that the LBT result is idle, and does not perform transmission in a case that the LBT result is busy (LBT-busy). The time of the transmission opportunity is referred to as Channel Occupancy Time (COT). The COT is a total time length of all transmission and a gap within a prescribed time period in a transmission opportunity, and may be less than or equal to a Maximum COT (MCOT). The MCOT may be determined based on a channel access priority class. The channel access priority class may be associated with the contention window size.

The channel access priority class is defined and used For example, four channel access priority classes (channel access priority class 1, channel access priority class 2, channel access priority class 3, and channel access priority class 4) are defined and used. In the channel access priority class 1, the minimum contention window size is 3 slots, the maximum contention window size is 7 slots, and allowed contention window sizes include two sizes (3 slots and 7 slots). In the channel access priority class 2, the minimum contention window size is 7 slots, the maximum contention window size is 15 slots, and allowed contention window sizes includes two sizes (7 slots, 15 slots). In the channel access priority class 3, the minimum contention window size is 15 slots, the maximum contention window size is 1023 slots, and allowed contention window sizes include seven sizes (15 slots, 31 slots, 63 slots, 127 slots, 255 slots, 511 slots, and 1023 slots). In the channel access priority class 4, the minimum contention window size is 15 slots, the maximum contention window size is 1023 slots, and the allowed contention window sizes include seven sizes (15 slots, 31 slots, 63 slots, 127 slots, 255 slots, 511 slots, and 1023 slots). The contention window size may represent the number of counts counted for each slot.

In a case that it is determined that the channel is busy by the carrier sensing in the sensing slot time, the terminal apparatus 1 performs sensing to determine whether the channel is idle in a defer duration. The defer duration includes 16 us and multiple sensing slots. The number of sensing slots included in the defer duration depends on the channel access priority class. In the channel access priority class 1, approximately two sensing slots are configured in the defer duration. In the channel access priority class 2, approximately two sensing slots are configured in the defer duration. In the channel access priority class 3, approximately three sensing slots are configured in the defer duration. In the channel access priority class 4, approximately seven sensing slots are configured in the defer duration. In a case that the terminal apparatus 1 determines that the channel is busy in the defer duration, the terminal apparatus 1 determines again whether the channel is idle in a new defer duration. In a case that it is determined that the channel is idle in the defer duration, the terminal apparatus 1 decrements the counter value configured based on the contention window size, continuously performs carrier sensing in each sensing slot time, and determines whether the channel is idle.

For example, for the channel access priority class 1, the maximum COT of 2 ms is used. For example, for the channel access priority class 2, the maximum COT of 3 ms is used. For example, for the channel access priority class 2, the maximum COT of 4 ms is used For example, for the channel access priority class 3, the maximum COT of 6 ms is used. For example, for the channel access priority class 3, the maximum COT of 8 ms is used. For example, for the channel access priority class 3, the maximum COT of 10 ms is used. For example, for the channel access priority class 4, the maximum COT of 6 ms is used. For example, for the channel access priority class 4, the maximum COT of 8 ms is used. For example, for the channel access priority class 4, the maximum COT of 10 ms is used.

In the sidelink resource assignment mode 2, the number of resources to be reserved is configured by the RRC signalling or is pre-configured. In a temporal axis of a series of resources, the second single unit resource or the third single unit resource other than the first single unit resource is a resource to be reserved. An interval (an interval in units of milliseconds (ms) between the first single unit resource and the second single unit resource, and an interval between the second single unit resource and the third single unit resource are configured by the RRC signalling or pre-configured.

In the sidelink resource assignment mode 2, in a case that the RSRP of the PSSCH or the RSRP of the PSCCH that is transmitted by another terminal apparatus 1 and detected is larger than the configured value, the terminal apparatus 1 excludes the reserved resource corresponding to the PSSCH or the PSCCH from the resource that the terminal apparatus 1 itself selects and the resource that the terminal apparatus 1 itself reserves.

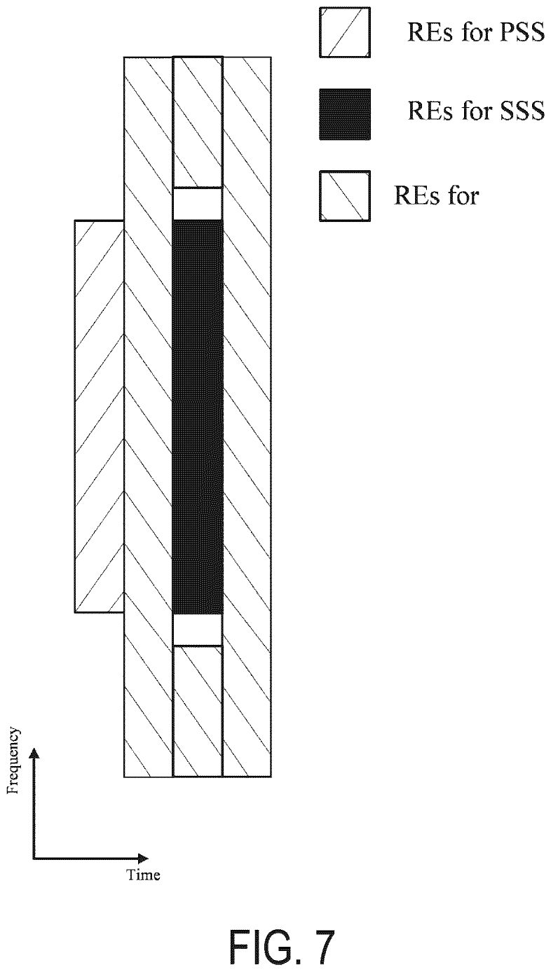

FIG. 7 is a diagram illustrating a configuration example of the SS/PBCH block. In FIG. 7, a horizontal axis represents a time domain (OFDM symbol index l_{sym}), and a vertical axis represents a frequency domain. A black colored block represents a set of resource elements for the PSS. A block with upper right diagonal lines in FIG. 7 represents a set of resource elements for the SSS. A block with upper left diagonal lines in FIG. 7 represents a set of resource elements for the PBCH and a set of resource elements for the DMRS for the PBCH (the DMRS related to the PBCH, the DMRS included in the PBCH, or the DMRS corresponding to the PBCH).

As illustrated in FIG. 7, the SS/PBCH block includes the PSS, the SSS, and the PBCH. The SS/PBCH block includes four contiguous OFDM symbols. The SS/PBCH block includes 240 subcarriers. The PSS is assigned to the 57th to the 183rd subcarriers in the first OFDM symbol. Values of the 1st to the 56th subcarriers in the first OFDM symbol may be set to 0. Values of the 184th to the 240th subcarriers in the first OFDM symbol may be set to 0. Values of the 49th to the 56th subcarriers in the third OFDM symbol may be set to 0. Values of the 184th to the 192nd subcarriers in the third OFDM symbol may be set to 0. In the 1st to the 240th subcarriers in the second OFDM symbol, the PBCH is assigned to the subcarrier to which the DMRS for the PBCH is not assigned. In the 1st to the 48th subcarriers in the third OFDM symbol, the PBCH is assigned to the subcarrier to which the DMRS for the PBCH is not assigned. In the 193rd to the 240th subcarriers in the third OFDM symbol, the PBCH is assigned to the subcarrier to which the DMRS for the PBCH is not assigned. In the 1st to the 240th subcarriers in the fourth OFDM symbol, the PBCH is assigned to the subcarrier to which the DMRS for the PBCH is not assigned.

The antenna ports of the PSS, the SSS, the PBCH, and the DMRS for the PBCH in one SS/PBCH may be the same.

The PBCH may be inferred from the DMRS for the PBCH. With respect to the DMRS for the PBCH, only in a case that two symbols, a symbol for the PBCH in a certain antenna port and a symbol for the DMRS in the antenna port, are included in SS/PBCH blocks transmitted in the same slot and having the same SS/PBCH block index, the channel on which the former symbol is transmitted can be inferred from the channel on which the latter symbol is transmitted.

The DL DMRS is a general term of the DMRS for the PBCH, the DMRS for the PDSCH, and the DMRS for the PDCCH.

A set of antenna ports for the DMRS for the PDSCH (the DMRS related to the PDSCH, the DMRS included in the PDSCH, or the DMRS corresponding to the PDSCH) may be given based on a set of antenna ports for the PDSCH. The set of antenna ports for the DMRS for the PDSCH may be the same as the set of antenna ports for the PDSCH.

Transmission of the PDSCH and transmission of the DMRS for the PDSCH may be indicated (may be scheduled) by one DCI format. The PDSCH and the DMRS for the PDSCH may collectively be referred to as the PDSCH. The transmission of the PDSCH may be transmission of the PDSCH and the DMRS for the PDSCH.

The PDSCH may be inferred from the DMRS for the PDSCH. With respect to the DMRS for the PDSCH, only in a case that two symbols, a symbol for the PDSCH in a certain antenna port and a symbol for the DMRS in the antenna port, are in the same resource in which the PDSCH is scheduled, in the same slot, and in the same Precoding Resource Group (PRG), the channel on which the former symbol is transmitted can be inferred from the channel on which the latter symbol is transmitted.

The antenna port of the DMRS for the PDCCH (the DMRS related to the PDCCH, the DMRS included in the PDCCH, or the DMRS corresponding to the PDCCH) may be the same as the antenna port for the PDCCH.

The PDCCH may be inferred from the DMRS for the PDCCH. With respect to the DMRS for the PDCCH, only in a case that two symbols, a symbol for the PDCCH in a certain antenna port and a symbol for the DMRS in the antenna port, are in a resource that may be assumed, by a terminal apparatus, to use the same precoding (that is, a resource within one REG bundle), the channel on which the former symbol is transmitted can be inferred from the channel on which the latter symbol is transmitted.

The Broadcast Channel (BCH), the UpLink Shared CHannel (UL-SCH), and the DownLink Shared CHannel (DL-SCH) are transport channels. A channel used in the MAC layer is referred to as a transport channel. A unit of the transport channel used in the MAC layer is also referred to as a transport block or the MAC Protocol Data Unit (MAC PDU). In the MAC layer, HARQ control is performed for each transport block. The transport block is a unit of data delivered to the physical layer by the MAC layer. In the physical layer, the transport block is mapped to a codeword, and modulation processing is performed for each codeword.

The UL-SCH and the DL-SCH are provided to each serving cell. The BCH is provided to the PCell. The BCH need not be provided to the PSCell and the SCell.

A Broadcast Control CHannel (BCCH), a Common Control CHannel (CCCH) and a Dedicated Control CHannel (DCCH) are logical channels. The BCCH is a channel of the RRC layer used for delivering a MIB or system information. The CCCH may be used for the terminal apparatus 1 that is not connected by the RRC. The DCCH may be used for transmitting a dedicated RRC message at least to the terminal apparatus 1. The DCCH may be used for the terminal apparatus 1 in a state of an RRC-connected mode.

The RRC message includes one or multiple RRC parameters (information elements and higher layer parameters). For example, the RRC message may include the MIB. For example, the RRC message may include the system information (the System Information Block (SIB) and the MIB). The SIB is a general term for various types of SIBs (for example, SIB1, SIB2, and the like). For example, the RRC message may include a message corresponding to the CCCH. For example, the RRC message may include a message corresponding to the DCCH. The RRC message is a general term for a shared RRC message and the dedicated RRC message.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

The higher layer parameter is a parameter included in the RRC message or the MAC Control Element (MAC CE). The higher layer parameter is a general term for the MIB, the system information, the message corresponding to the CCCH, the message corresponding to the DCCH, and information included in the MAC CE. In a case that the higher layer parameter is included in the RRC message, the higher layer parameter may be referred to as the RRC parameter or an RRC configuration.

The higher layer parameter may be a cell-specific parameter or a UE-specific parameter. The cell-specific parameter is a parameter including a common configuration in a cell. The UE-specific parameter is a parameter including a configuration that may differently be configured for each UE.

The base station apparatus may indicate a change of the cell-specific parameter by reconfiguration with random access. The UE may change the cell-specific parameter before triggering the random access. The base station apparatus may indicate a change of the UE-specific parameter by reconfiguration with or without the random access. The UE may change the UE-specific parameter before or after the random access.

Procedures performed by the terminal apparatus 1 include at least a part or all of the following 5A to 5C. 5A is a cell search. 5B is random access. 5C is data communication.

The cell search is a procedure used by the terminal apparatus 1 for synchronizing with a cell in a time domain and/or a frequency domain and detecting a physical cell identity. The terminal apparatus 1 may detect the physical cell identity by synchronizing with a cell in a time domain and/or a frequency domain by means of the cell search.

A sequence of the PSS is given based on at least the physical cell identity. A sequence of the SSS is given based on at least the physical cell identity.

A SS/PBCH block candidate specifies a resource in which transmission of the SS/PBCH block may be present. The SS/PBCH block may be transmitted in a resource specified as the SS/PBCH block candidate. The base station apparatus 3 may transmit the SS/PBCH block in the SS/PBCH block candidate. The terminal apparatus 1 may receive (detect) the SS/PBCH block in the SS/PBCH block candidate.

A set of the SS/PBCH block candidates in a half radio frame is also referred to as an SS burst set. The SS burst set is also referred to as a transmission window, an SS transmission window, or a Discovery Reference Signal (DRS) transmission window. The SS burst set is a general term including at least a first SS burst set and a second SS burst set.

The base station apparatus 3 transmits one or multiple indexed SS/PBCH blocks in a predetermined cycle. The terminal apparatus 1 may detect at least one SS/PBCH block out of the one or multiple indexed SS/PBCH blocks. The terminal apparatus 1 may attempt to decode the PBCH included in the SS/PBCH block.

The random access is a procedure including at least a part or all of a message 1, a message 2, a message 3, and a message 4.

The message 1 is a procedure in which the terminal apparatus 1 transmits the PRACH. The terminal apparatus 1 transmits the PRACH in one PRACH opportunity selected out of one or multiple PRACH opportunities at least based on an index of the SS/PBCH block candidate detected based on a cell search.

The message 2 is a procedure in which the terminal apparatus 1 attempts to detect the DCI format 1_0 with a Cyclic Redundancy Check (CRC) scrambled by a RAndom access-Radio Network Temporary Identifier (RA-RNTI). The terminal apparatus 1 may attempt to detect the DCI format 1_0 in a search space set.

The message 3 (Msg 3) is a procedure of transmitting the PUSCH scheduled by a random access response grant included in the DCI format 1_0 detected in a message 2 procedure. The random access response grant is indicated by the MAC CE included in the PDSCH scheduled by the DCI format 1_0.

The PUSCH scheduled based on the random access response grant is either a message 3 PUSCH or the PUSCH. The message 3 PUSCH includes a contention resolution identifier MAC CE. The contention resolution identifier MAC CE includes a contention resolution identifier.

Retransmission of the message 3 PUSCH is scheduled by the DCI format 0_0 with a CRC scrambled by a temporary C-RNTI (TC-RNTI).

The message 4 is a procedure to attempt to detect the DCI format 1_0 with a CRC scrambled by either the C-RNTI or the TC-RNTI. The terminal apparatus 1 receives the PDSCH scheduled based on the DCI format 1_0. The PDSCH includes the contention resolution identifier.

The data communication is a general term for downlink communication and uplink communication.

In the data communication, the terminal apparatus 1 attempts to detect the PDCCH (attempts monitoring the PDCCH or monitors the PDCCH) in a resource specified at least based on either or both of the control resource set and the search space set. This is also referred to as “the terminal apparatus 1 attempts to detect the PDCCH in the control resource set”, “the terminal apparatus 1 attempts to detect the PDCCH in the search space set”, “the terminal apparatus 1 attempts to detect the PDCCH candidate in the control resource set”, “the terminal apparatus 1 attempts to detect the PDCCH candidate in the search space set”, “the terminal apparatus 1 attempts to detect the DCI format in the control resource set”, or “the terminal apparatus 1 attempts to detect the DCI format in the search space set”. Monitoring of the PDCCH may be equivalent to monitoring of the DCI format in the PDCCH.

The control resource set is a set of resources configured according to the number of resource blocks and a prescribed number of OFDM symbols in a slot.

A set of resources for the control resource set may be specified by the higher layer parameter. The number of OFDM symbols included in the control resource set may be specified by the higher layer parameter.

The PDCCH may also be referred to as the PDCCH candidate.

The search space set is defined as a set of the PDCCH candidates. The search space set may be a Common Search Space (CSS) set or a UE-specific Search Space (USS) set.

The CSS set is a general term of a type 0 PDCCH common search space set, a type 0a PDCCH common search space set, a type 1 PDCCH common search space set, a type 2 PDCCH common search space set, and a type 3 PDCCH common search space set. The USS set is also referred to as a UE-specific PDCCH search space set.

The type 0 PDCCH common search space set may be used as the common search space set with the index 0. The type 0 PDCCH common search space set may be the common search space set with the index 0.

The search space set is associated to (included in or corresponds to) the control resource set. The index of the control resource set related to the search space set may be indicated by the higher layer parameter.

For the search space set, a part or all of 6A to 6C may be indicated by at least the higher layer parameter. The 6A is a PDCCH monitoring periodicity. The 6B is a PDCCH monitoring pattern in a slot. The 6C is a PDCCH monitoring offset.

A monitoring opportunity for a search space set may correspond to one or more OFDM symbols to which the first OFDM symbol of the control resource set associated with the search space set is assigned.

The monitoring opportunity of the search space set may correspond to a resource identified by the first OFDM symbol of the control resource set associated with the search space set. The monitoring opportunity of the search space set may be given based on at least a part or all of the PDCCH monitoring periodicity, the PDCCH monitoring pattern in a slot, and the PDCCH monitoring offset.

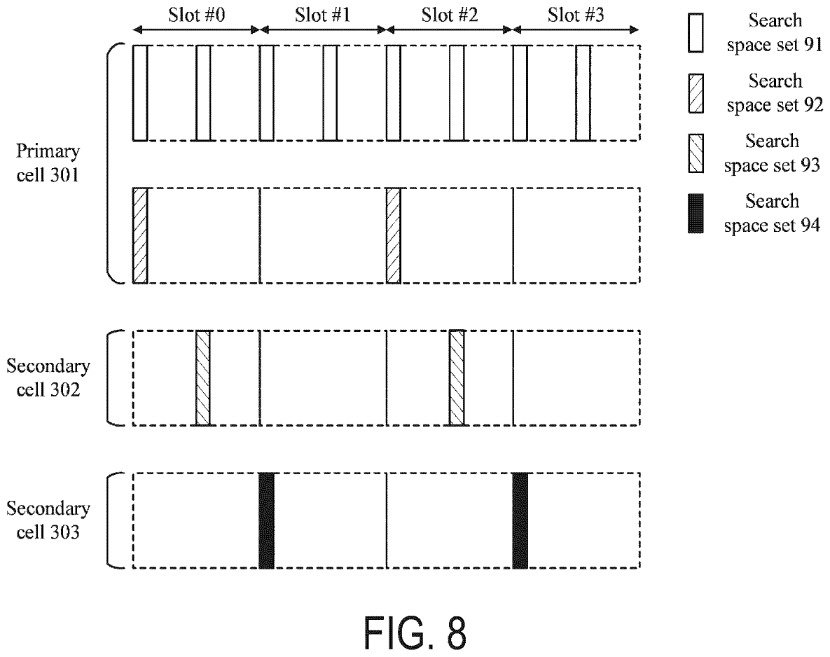

FIG. 8 is a diagram illustrating an example of the monitoring opportunity of the search space set according to an aspect of the present embodiment. In FIG. 8, a search space set 91 and a search space set 92 are sets of a primary cell 301, a search space set 93 is a set of a secondary cell 302, and a search space set 94 is a set of a secondary cell 303.

In FIG. 8, the white colored block is the search space set 91, the search space set 92 shaded with upper right diagonal lines, the search space set 93 shaded with upper left diagonal lines, and the black colored search space set 94.

In FIG. 8, the PDCCH monitoring periodicity for the search space set 91 is set to 1 slot, the PDCCH monitoring offset for the search space set 91 is set to 0 slots, and the PDCCH monitoring pattern for the search space set 91 is set to [1, 0, 0, 0, 0, 0, 0, 1, 0, 0, 0, 0, 0, 0]. That is, the monitoring opportunity for the search space set 91 corresponds to the first OFDM symbol (OFDM symbol #0) and the 8th OFDM symbol (OFDM symbol #7) in each slot.

In FIG. 8, the PDCCH monitoring periodicity for the search space set 92 is set to 2 slots, the PDCCH monitoring offset for the search space set 92 is set to 0 slots, and the PDCCH monitoring pattern for the search space set 92 is set to [1, 0, 0, 0, 0, 0, 0, 0, 0, 0, 0, 0, 0, 0]. That is, the monitoring opportunity for the search space set 92 corresponds to the first OFDM symbol (OFDM symbol #0) in even-numbered slots.

In FIG. 8, the PDCCH monitoring periodicity for the search space set 93 is set to 2 slots, the PDCCH monitoring offset for the search space set 93 is set to 0 slots, and the PDCCH monitoring pattern for the search space set 93 is set to [0, 0, 0, 0, 0, 0, 0, 1, 0, 0, 0, 0, 0, 0]. That is, the monitoring opportunity for the search space set 93 corresponds to the 8th OFDM symbol (OFDM symbol #7) in even-numbered slots.

In FIG. 8, the PDCCH monitoring periodicity for the search space set 94 is set to 2 slots, the PDCCH monitoring offset for the search space set 94 is set to 1 slot, and the PDCCH monitoring pattern for the search space set 94 is set to [1, 0, 0, 0, 0, 0, 0, 0, 0, 0, 0, 0, 0, 0]. That is, the monitoring opportunity for the search space set 94 corresponds to the first OFDM symbol (OFDM symbol #0) in odd-numbered slots.

For the type 0 PDCCH common search space set, the DCI format with a Cyclic Redundancy Check (CRC) sequence scrambled at least by a System Information-Radio Network Temporary Identifier (SI-RNTI) may be used.

For the type 0a PDCCH common search space set, the DCI format with a CRC sequence scrambled at least by the SI-RNTI may be used.

For the type 1 PDCCH common search space set, the DCI format with a CRC sequence scrambled at least by a Random Access-Radio Network Temporary Identifier (RA-RNTI) or a CRC sequence scrambled by the Temporary Cell-Radio Network Temporary Identifier (TC-RNTI) may be used.

For the type 2 PDCCH common search space set, the DCI format with a CRC sequence scrambled by a Paging-Radio Network Temporary Identifier (P-RNTI) may be used.

For the type 3 PDCCH common search space set, the DCI format with a CRC sequence scrambled by a Cell-Radio Network Temporary Identifier (C-RNTI) may be used.

For the UE-specific search space set, the DCI format with a CRC sequence scrambled by at least the C-RNTI may be used.

In the downlink communication, the terminal apparatus 1 detects the downlink DCI format. The detected downlink DCI format is at least used for resource assignment of the PDSCH. The detected downlink DCI format may be referred to as downlink assignment. The terminal apparatus 1 attempts to receive the PDSCH. The base station apparatus 3 may be notified of the HARQ-ACK corresponding to the PDSCH (the HARQ-ACK corresponding to the transport block included in the PDSCH) based on the PUCCH resource indicated based on the detected downlink DCI format.

In the uplink communication, the terminal apparatus 1 may detect the uplink DCI format. The detected uplink DCI format is used at least for resource assignment for the PUSCH.

The PUSCH transmission may be dynamically scheduled by a UL grant of the DCI, or the transmission may correspond to a grant Type 1 or grant Type 2 that is configured. The configured grant Type 1 PUSCH transmission is semi-statically configured so as to operate in a case of reception of the higher layer parameter of a configuredGrantConfig including an rrc-ConfiguredUplinkGrant without detection of the UL grant of the DCI The configured grant Type 2 PUSCH transmission is semi-statically scheduled by the UL grant of a valid activation DCI, after reception of the higher layer parameter of a configuredGrantConfig not including the rrc-ConfiguredUplinkGrant, according to these procedures. In a case that a configuredGrantConfigToAddModList is configured, the configured grant Type 1 and/or the configured grant Type 2 may be activated simultaneously with a valid BWP of the serving cell.

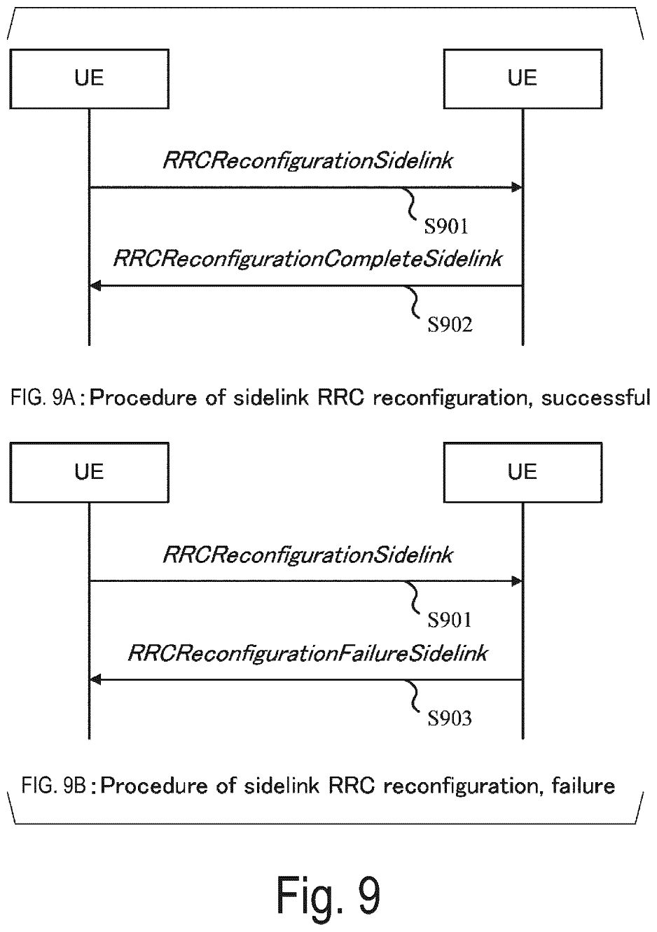

FIG. 9 is a diagram illustrating a sidelink RRC reconfiguration procedure. In FIG. 9, the purpose of this procedure is to change PC5 RRC connection, for example, to establish/change/release sidelink DRB, to (re)configure NR sidelink measurement and reporting, and to (re)configure sidelink CSI-RS resources and CSI reporting latency bound. The procedure of FIG. 9 may be (re)configuring measurement and reporting of sidelink positioning, and (re)configuring SL-PRS resources.

In S901 of FIG. 9, a UE transmits an RRCReconfigurationSidelink message to another UE. In FIG. 9A, the other UE receives S901, and transmits RRCReconfigurationCompleteSidelink in a case that PC5-RRC reconfiguration is successful (S902). The UE may consider, in a case of receiving RRCReconfigurationCompleteSidelink, applying the configuration in the corresponding RRCReconfiguration Sidelink message. In FIG. 9B, the other UE receives S901, and transmits RRCReconfigurationfailureSidelink in a case that the PC5-RRC reconfiguration fails (S903).

FIG. 9 may be used as a procedure for PC5 connection in the case of the sidelink positioning. In FIG. 9, in a case that the sidelink positioning is performed, a Tx UE (a UE that transmits SL-PRS) may transmit RRCReconfigurationSidelink. The Tx UE may consider, in a case of receiving RRCReconfigurationCompleteSidelink, applying the configuration in the corresponding RRCReconfigurationSidelink message. In a case of receiving RRCReconfigurationCompleteSidelink, the Tx UE may determine that there is a PC5 connection with the UE that has transmitted RRCReconfigurationCompleteSidelink. On the other hand, in a case of not having received RRCReconfigurationCompleteSidelink, the Tx UE may determine that there is no PC5 connection with the corresponding UE. For example, in cases that the Tx UE receives RRCReconfigurationfailureSidelink, that there has been no message response, and that no procedure for the PC5 connection has been initiated, the Tx UE may determine that there is no PC5 connection.

Note that the procedure for the PC5 connection in the case of the sidelink positioning is not limited to the procedure illustrated in FIG. 9, and may be a procedure in which the Tx UE and another UE make a sidelink connection to initiate the sidelink positioning. For example, the sidelink positioning is not limited to the messages in FIG. 9, and other messages for the sidelink positioning may be used.

The operation of the sidelink positioning according to the present embodiment will now be described. The sidelink positioning may be performed by combining a part of the processing in the sidelink communication described above and the operation of the sidelink positioning described below. In the present embodiment, the terminal apparatus 1 that transmits the SL-PRS is denoted by Tx UE and the terminal apparatus 1 that receives a signal transmitted by the Tx UE is denoted by Rx UE. The Rx UE uses the SL-PRS received from the Tx UE to perform the sidelink positioning with the Tx UE.

Note that, in a case that the positioning using both the Uu interface and the PC5 interface is performed, the processing between a base station apparatus and a terminal apparatus may use the above-described processing in the uplink and the downlink. For example, the terminal apparatus 1 may perform the positioning by using the PRS via the Uu interface in addition to the sidelink positioning via the PC5 interface.

The SideLink-Positioning Reference Signal (SL-PRS) is the reference signal used to measure the position of the terminal apparatus 1 in the sidelink positioning. The SL-PRS is included in the sidelink physical signal. The radio transmission and/or reception unit 10 (or the radio transmitting unit 10a) may transmit the SL-PRS included in the sidelink physical signal. The radio transmission and/or reception unit 10 (or the radio receiving unit 10b) may receive the SL-PRS included in the sidelink physical signal. The SL-PRS may be mapped in the resource pool on a per slot basis. The resource to which the SL-PRS is mapped may be referred to as an SL-PRS resource. The SL-PRS resource may not need to include an AGC symbol and a GAP symbol. An SL-PRS resource ID may be given by the higher layer parameter, may be configured by the LMF, may be configured in the terminal apparatus in advance, or may be configured by the terminal apparatus.

The sequence of the SL-PRS may be generated by using a pseudo-random sequence. The pseudo-random sequence may be initialized by using at least the slot number, the symbol number, and the SL-PRS sequence ID. The SL-PRS sequence ID may be given by the higher layer parameter, may be configured by the LMF, may be configured in the terminal apparatus in advance, or may be calculated by the terminal apparatus (for example, the Tx UE).

The resource pool applied to the sidelink positioning may be a Dedicated resource pool and/or a Shared resource pool. Note that the configuration of the Dedicated resource pool may be different from the configuration of the Shared resource pool.

The SL-PRS may be mapped to the SL-PRS resource in a slot. The SL-PRS may be mapped to the resource element in the SL-PRS resource based on the number of symbols of the SL-PRS, a Comb size, a resource element offset (RE-offset), and the like.

The number of symbols of the SL-PRS is the number of SL-PRSs mapped in a symbol direction. For example, the number of symbols of the SL-PRS may include some or all of 1, 2, 4, 6, 8, and 12. The number of symbols of the SL-PRS may be configured by a combination of the number of symbols of the SL-PRS and the Comb size.

The symbol offset of the SL-PRS is an offset to indicate the position of the first symbol to which the SL-PRS in the slot is mapped. For example, the symbol offset of the SL-PRS may be an offset from the first symbol number of the resource pool to which the SL-PRS is mapped. For example, the symbol offset of the SL-PRS may include some or all of the values from 0 to 12. For example, the symbol offset of the SL-PRS may be the number of symbols of the 1^{st} stage SCI.

The Comb size of the SL-PRS frequency resource is an interval in a frequency direction to which the SL-PRS is mapped. For example, the Comb size may include some or all of 1, 2, 4, 6, 8, and 12.

The resource element offset of the SL-PRS frequency resource is an offset to indicate a position in the frequency direction to which the SL-PRS is mapped. The resource element offset may be a positive integer smaller than the Comb size. For example, in a case that the Comb size is 4, the resource element offsets are 0, 1, 2, and 3.

The symbols of the SL-PRS resource in a slot may be contiguous symbols. The symbols of the SL-PRS resource in a slot may be non-contiguous symbols.

As a positioning method in the sidelink positioning, SL Time Difference Of Arrival (SL-TDOA), SL Angle of Departure (SL-AoA), SL Angle of Arrival (SL-AoD), Multi-Round Trip Time (Multi RTT), or the like is used. The position information of the terminal apparatus 1 is calculated by using the SL-PRS received by the radio receiving unit 10b. The position information of the terminal apparatus 1 may be calculated by the terminal apparatus 1 or may be calculated by the higher layer and/or the LMF of the terminal apparatus 1.

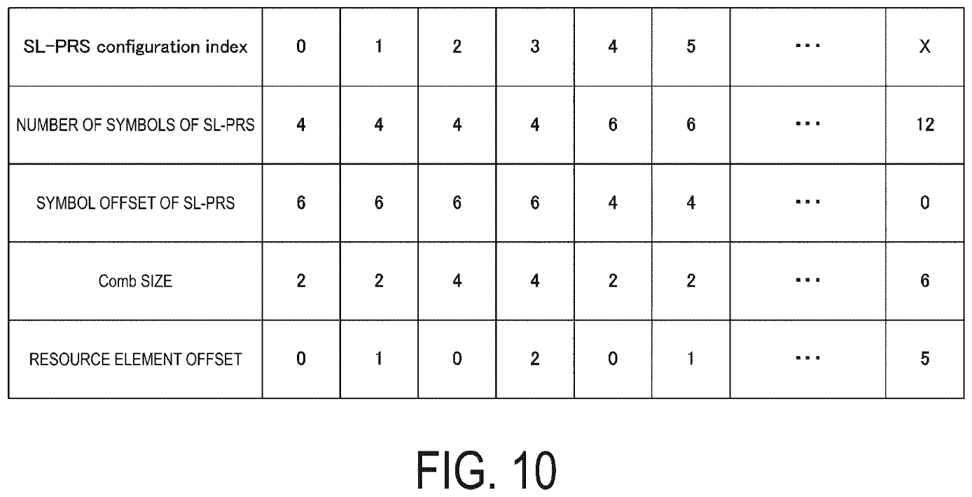

FIG. 10 is a diagram illustrating an example of the SL-PRS configuration table according to an aspect of the present embodiment. The SL-PRS configuration table includes a parameter set for configuring the SL-PRS and an SL-PRS configuration index. The parameter set for configuring the SL-PRS may include some or all of the number of symbols of the SL-PRS, the symbol offset of the SL-PRS, the Comb size, and the resource element offset. The SL-PRS configuration index is an index of the parameter set for configuring the SL-PRS. For example, in a case that the SL-PRS configuration index is 1, the number of symbols of the SL-PRS is 4, the symbol offset is 6, the Comb size is 2, and the resource element offset is 1. FIG. 10 illustrates an example in which the SL-PRS configuration index is from 0 to X.

The parameter set included in the SL-PRS configuration table is not limited to the one in FIG. 10. For example, a combination of the number of symbols of the SL-PRS and the Comb size may be one parameter. For example, the SL-PRS configuration table may not need to include the symbol offset of the SL-PRS. For example, in FIG. 10, the SL-PRS configuration table may include a combination of some of the values of the parameter set for configuring the SL-PRS instead of a combination of all the values. For example, the SL-PRS configuration table may include only the Comb size. For example, in a case that the only parameter included in the SL-PRS configuration table is the Comb size, the Comb size and the SL-PRS configuration index may be associated with each other, or the SL-PRS configuration index may not need to be configured.

In FIG. 10, the SL-PRS configuration table may be a table that varies between the case of the Dedicated resource pool and the case of the Shared resource pool. Some or all of the configuration values pre-configured for the terminal apparatus may be configured for SL-PRS configuration indexes with small number values. For example, in FIG. 10, the SL-PRS configuration indexes 0 to 3 may be configuration values for the SL-PRS configuration pre-configured for the terminal apparatus.

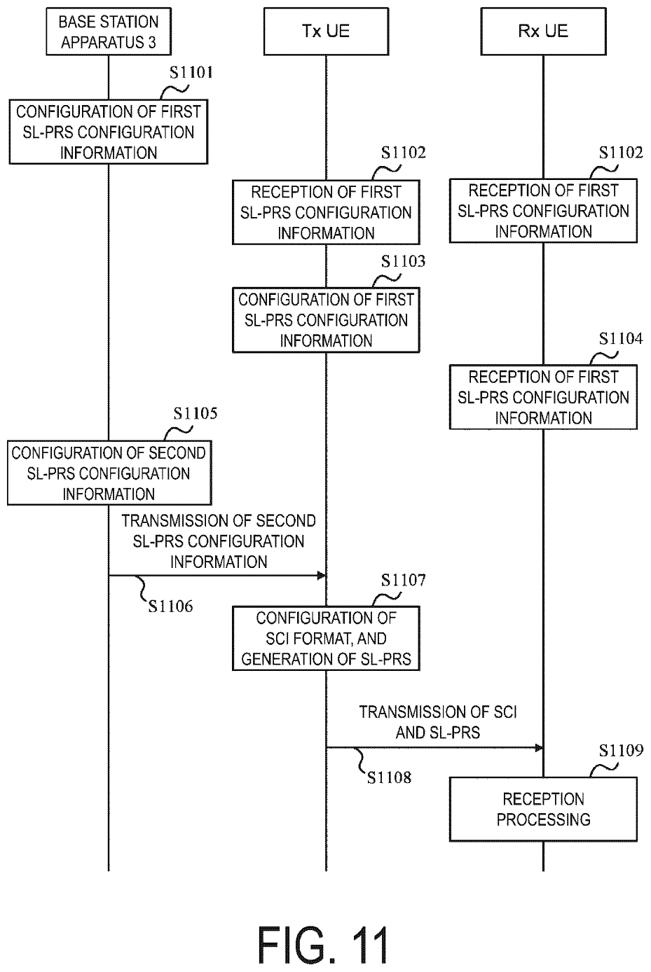

FIG. 11 is a diagram illustrating an example of a configuration method in a case that multiple pieces of SL-PRS configuration information are configured in the base station apparatus according to one aspect of the present embodiment. In FIG. 11, the Tx UE may be a terminal apparatus positioned within the coverage of the base station apparatus 3, and may be, for example, the terminal apparatus 1A or the terminal apparatus 1B in FIG. 1.

In S1101, the higher layer processing unit 34 of the base station apparatus 3 configures first SL-PRS configuration information. The first SL-PRS configuration information is a part of multiple parameter sets for configuring the SL-PRS. S1101 may be processing of the MAC layer and/or the RRC layer. Note that the first SL-PRS configuration information may be referred to as the first information.

In S1101, the base station apparatus 3 may select multiple SL-PRS configuration indexes from the SL-PRS configuration indexes in FIG. 10. For example, the base station apparatus 3 may select the SL-PRS configuration indexes from 0 to 7, may select the indexes from 2 to 9, may select the indexes from 0 to 3, or may select the indexes from 5 to 7. The base station apparatus 3 may select the SL-PRS configuration index in order of increasing number value.

In S1101, in a case that the parameters in the SL-PRS configuration table of FIG. 10 include only the Comb size, the base station apparatus 3 may select multiple SL-PRS configuration indexes, or may select multiple Comb sizes.

The number of indexes included in the first SL-PRS configuration information may be equal to or less than the number of indexes that can be notified in a field of the DCI format and/or the SCI format for notification of the configuration of the SL-PRS. For example, in a case that the index that can be notified in the field of the SL-PRS configuration in the DCI format and/or the SCI format is 8, the number of indexes included in the first SL-PRS configuration information may be 8 or less. For example, in a case that the field of the SL-PRS configuration in the DCI format is 3 bits, the first SL-PRS configuration information may be indexes from 0 to 7, or may be indexes from 5 to 7.

In S1102, in a case that the Tx UE is within the coverage of the base station apparatus 3, the higher layer processing unit 14 of the Tx UE receives the first SL-PRS configuration information. In S1102, in a case that the Rx UE is within the coverage of the base station apparatus 3, the higher layer processing unit 14 of the Rx UE receives the first SL-PRS configuration information.

In S1103, the higher layer processing unit 14 in the PC5 of the Tx UE configures the first SL-PRS configuration information received in S1102. S1103 may be processing of the MAC layer and/or processing of the RRC layer in the PC5. Note that S1103 may be included in the procedure for the PC5 connection.

In S1104, the higher layer processing unit 14 in the PC5 of the Rx UE receives the first SL-PRS configuration information. At this time, in a case that there is a PC5 connection between the Rx UE and the Tx UE, the higher layer processing unit 14 in the PC5 of the Rx UE receives the first SL-PRS configuration information.

In S1105, the base station apparatus 3 configures second SL-PRS configuration information in the DCI format. The second SL-PRS configuration information may be one of the parameter sets included in the first SL-PRS configuration information. For example, in a case that the first SL-PRS configuration information includes indexes from 0 to 7, the second SL-PRS configuration information may be an index 0 or an index 5. For example, in a case that the first SL-PRS configuration information includes multiple Comb sizes (2, 4, 6), the second SL-PRS configuration information may be 4. The base station apparatus 3 configures the second SL-PRS configuration information in the field of the DCI format for notification of the configuration of the SL-PRS. Note that the second SL-PRS configuration information may be referred to as the second information.

In S1106, the base station apparatus 3 transmits the DCI to the Tx UE. At this time, the DCI format includes the second SL-PRS configuration information.

In S1107, the Tx UE configures the SCI format and generates the SL-PRS. In S1107, the Tx UE configures one parameter set in the field of the SCI format for notification of the configuration of the SL-PRS. The information configured in the field of the SCI format for notification of the SL-PRS configuration information may be referred to as third information.

In S1107, in a case that the Tx UE acquires the second SL-PRS configuration information, the Tx UE performs the following processing. In a case of determining that there is a PC5 connection to the Rx UE, the Tx UE may configure the second SL-PRS configuration information indicated by the DCI in the field of the SCI format for notification of the configuration of the SL-PRS. On the other hand, in a case of determining that there is no PC5 connection to the Rx UE, the Tx UE may configure a configuration value pre-configured for the Tx UE, or may configure the second SL-PRS configuration information, in the field of the SCI format for notification of the configuration of the SL-PRS.

In S1107, in a case of not acquiring the second SL-PRS configuration information, the Tx UE performs the following processing. In the case of determining that there is a PC5 connection to the Rx UE, the Tx UE may select one piece of information from among the parameter sets included in the first SL-PRS configuration information, and configure the selected one parameter in the field of the SCI format for notification of the configuration of the SL-PRS. On the other hand, in a case of determining that there is no PC5 connection to the Rx UE, the Tx UE may configure a configuration value pre-configured for the Tx UE in the field of the SCI format for notification of the configuration of the SL-PRS.

In S1107, the Tx UE generates the SL-PRS by using one configured parameter set (third information). At this time, parameters not included in the parameter set configured in S1107 may be given by higher layer parameters, may be configured by the LMF, may be pre-configured in the terminal apparatus, or may be configured by the terminal apparatus (for example, Tx UE).

In S1108, the Tx UE transmits the SCI and the SL-PRS to the Rx UE. At this time, the field of the SCI format for notification of the configuration of the SL-PRS includes one parameter set configured by the Tx UE.

In S1109, the Rx UE performs the reception processing. The Rx UE may specify the SL-PRS resource by using the parameter set included in the field of the SCI format for notification of the configuration of the SL-PRS, and perform the reception processing for the sidelink positioning. Note that in a case that information necessary for the Rx UE to specify the SL-PRS resource is insufficient, the Rx UE may use information held by the Rx UE in advance, information given by the higher layer parameter, information acquired from the LMF, or the like.

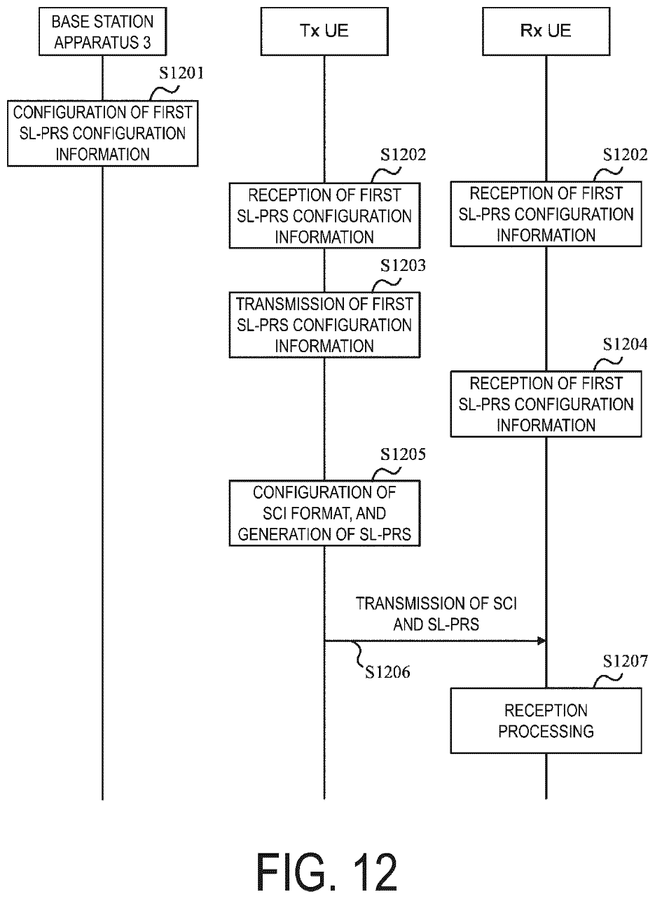

FIG. 12 is a diagram illustrating an example of a configuration method in a case that one piece of SL-PRS configuration information is configured in the base station apparatus according to one aspect of the present embodiment. Although FIG. 11 illustrates a case where multiple pieces of SL-PRS configuration information are configured in the base station apparatus, FIG. 12 illustrates a case where one piece of SL-PRS configuration information is configured in the base station apparatus. Hereinafter, differences from FIG. 11 will mainly be described.

In S1201, the higher layer processing unit 34 of the base station apparatus 3 configures the first SL-PRS configuration information. The first SL-PRS configuration information is one of the multiple parameter sets for configuring the SL-PRS. S1201 may be processing of the MAC layer and/or processing of the RRC layer.

In S1201, the base station apparatus 3 may select one SL-PRS configuration index from the SL-PRS configuration indexes in FIG. 10. For example, the base station apparatus 3 may select the index 0 or may select the index 6.

In S1201, in a case that only the parameter included in the SL-PRS configuration table in FIG. 10 is the Comb size, the base station apparatus 3 may select one SL-PRS configuration index or may select one Comb size.

Steps from S1202 to S1204 are similar to steps from S1102 to S1104, respectively.

In S1205, the Tx UE configures the SCI format and generates the SL-PRS.

In S1205, in the case of determining that there is a PC5 connection to the Rx UE, the Tx UE may configure the first SL-PRS configuration information in the field of the SCI format for notification of the configuration of the SL-PRS. On the other hand, in the case of determining that there is no PC5 connection to the Rx UE, the Tx UE may configure the configuration value pre-configured for the Tx UE, or may configure the first SL-PRS configuration information, in the field of the SCI format for notification of the configuration of the SL-PRS.

In S1205, the Tx UE generates SL-PRS using one parameter set configured in S1205. At this time, parameters not included in the parameter set configured in S1205 may be given by higher layer parameters, may be configured by the LMF, may be pre-configured in the terminal apparatus, or may be configured by the terminal apparatus (for example, Tx UE).

S1206 and S1207 are similar to S1108 and S1109, respectively.

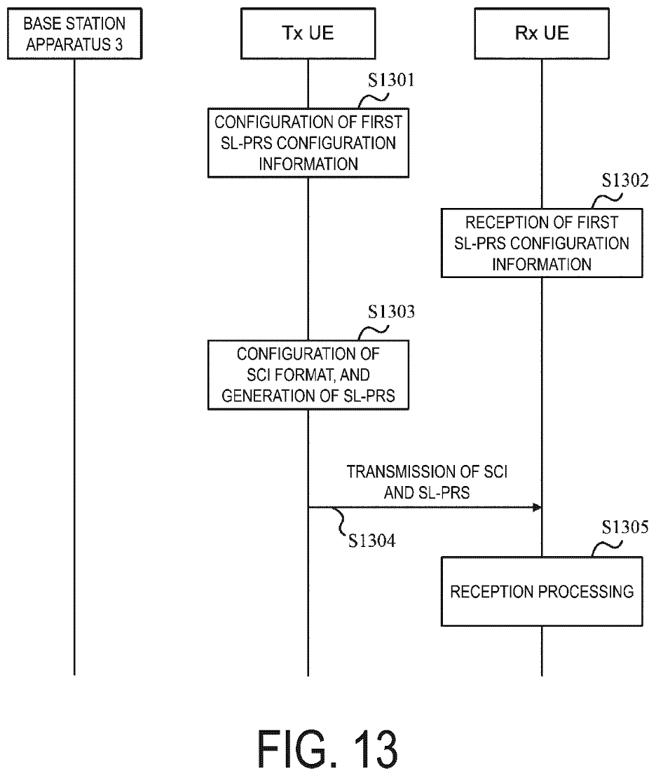

FIG. 13 is a diagram illustrating an example of a configuration method in a case that multiple pieces of SL-PRS configuration information are configured in the terminal apparatus according to an aspect of the present embodiment. Although FIG. 11 illustrates a case where multiple pieces of SL-PRS configuration information are configured in the base station apparatus, FIG. 13 illustrates a case where multiple pieces of SL-PRS configuration information are configured in the terminal apparatus. Hereinafter, differences from FIG. 11 will mainly be described.

In S1301, the higher layer processing unit 14 in the PC5 of the Tx UE configures the first SL-PRS configuration information. The first SL-PRS configuration information is a part of the multiple parameter sets for configuring the SL-PRS. S1301 may be processing of the MAC layer and/or processing of the RRC layer. In S1301, for example, multiple indexes are configured in the first SL-PRS configuration information.

S1302 is similar to S1104.

In S1303, the Tx UE configures the SCI format and generates the SL-PRS. In S1303, in the case of determining that there is a PC5 connection to the Rx UE, the Tx UE may select one piece of information from among the parameter sets included in the first SL-PRS configuration information, and configure the selected one parameter in the field of the SCI format for notification of the configuration of the SL-PRS. On the other hand, in the case of determining that there is no PC5 connection to the Rx UE, the Tx UE may configure the configuration value pre-configured for the Tx UE in the field of the SCI format for notification of the configuration of the SL-PRS.

S1304 and S1305 are similar to S1108 and S1109, respectively.

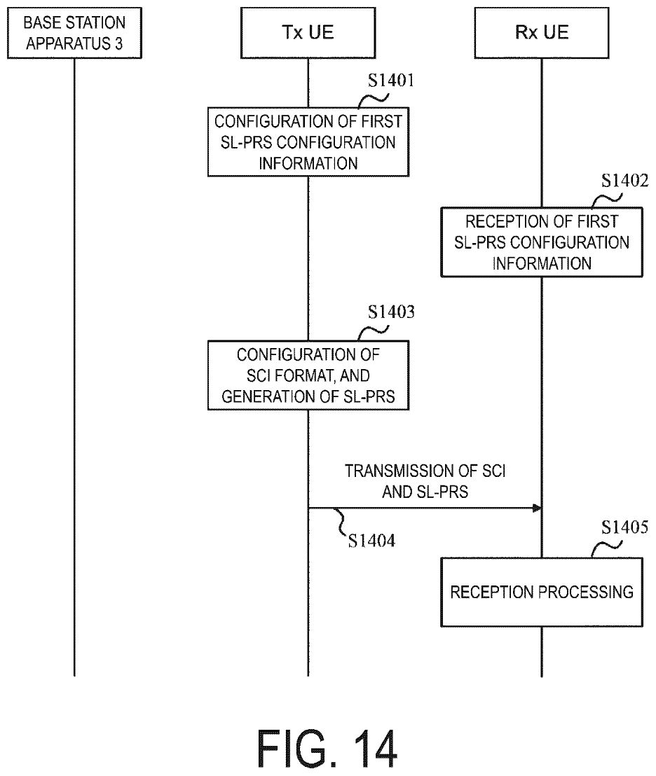

FIG. 14 is a diagram illustrating an example of a configuration method in a case that one piece of SL-PRS configuration information is configured in the terminal apparatus according to one aspect of the present embodiment. Although FIG. 13 illustrates a case where multiple pieces of SL-PRS configuration information are configured in the Tx UE, FIG. 14 illustrates a case where one piece of SL-PRS configuration information is configured in the Tx UE. Hereinafter, differences from FIG. 13 will mainly be described.

In S1401, the higher layer processing unit 14 in the PC5 of the Tx UE configures the first SL-PRS configuration information. The first SL-PRS configuration information is one of the multiple parameter sets for configuring the SL-PRS. S1401 may be processing of the MAC layer and/or processing of the RRC layer. In S1401, for example, one index is configured for the first SL-PRS configuration information.

S1402 is similar to S1302.

S1403 is similar to S1205.

S1404 and S1405 are similar to S1304 and S1305, respectively.

A program running on the base station apparatus 3 and the terminal apparatus 1 according to one aspect of the present invention may be a program (program that causes a computer to function) that controls a Central Processing Unit (CPU) and the like, such that the program implements the functions of the above-described embodiment according to one aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

The terminal apparatus 1 may include at least one processor, and at least one memory including a computer program instruction (computer program). The memory and the computer program instruction (computer program) may adopt a configuration of causing the terminal apparatus 1 to perform the operation and the processing described in the above embodiment by using a processor. The base station apparatus 3 may include at least one processor, and at least one memory including a computer program instruction (computer program). The memory and the computer program instruction (computer program) may adopt a configuration of causing the base station apparatus 3 to perform the operation and the processing described in the above embodiment by using a processor.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. A circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. A configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C, 1D) Terminal apparatus
3 Base station apparatus
10, 30 Radio transmission and/or reception unit
11, 31 Antenna unit
12, 32 RF unit
13, 33 Baseband unit
14, 34 Higher layer processing unit
15, 35 Medium access control layer processing unit
16, 36 Radio resource control layer processing unit

1. A terminal apparatus for communicating with a base station apparatus, the terminal apparatus comprising:
higher layer processing circuitry configured to receive a first parameter set and a second parameter set, wherein
each of the first parameter set and the second parameter set includes number of symbols of an SL-PRS, a Comb size, and a resource element offset,
the first parameter set is a parameter set used for a Dedicated resource pool, and the second parameter set is a parameter set used for a Shared resource pool.

2. A base station apparatus for communicating with a terminal apparatus, the base station apparatus comprising:
higher layer processing circuitry configured to configure a first parameter set and a second parameter set, wherein
each of the first parameter set and the second parameter set includes number of symbols of an SL-PRS, a Comb size, and a resource element offset,
the first parameter set is a parameter set used for a Dedicated resource pool, and the second parameter set is a parameter set used for a Shared resource pool.

3. A communication method for a terminal apparatus for communicating with a base station apparatus, the communication method comprising:
receiving a first set of parameters and a second set of parameters, wherein
each of the first parameter set and the second parameter set includes number of symbols of an SL-PRS, a Comb size, and a resource element offset,
the first parameter set is a parameter set used for a Dedicated resource pool, and the second parameter set is a parameter set used for a Shared resource pool.
